(19) United States
(12) Patent Application Publication
(10) Pub. No.: US 2016/0364553 A1
(43) Pub. Date: Dec. 15, 2016

(54) System, Apparatus And Method For Providing Protected Content In An Internet Of Things (IOT) Network

(71) Applicant: Intel Corporation

(72) Inventors: Ned M. Smith, Beaverton, OR (US); Rajesh Poornachandran, Portland, OR (US); Nathan Heldt-Sheller, Portland, OR (US)

(21) Appl. No.: 15/070,215

(22) Filed: Mar. 15, 2016

Related U.S. Application Data
(60) Provisional application No. 62/172,962, filed on Jun. 9, 2015.

(51) Int. Cl. G06F 21/10; H04L 29/06

(52) U.S. Cl. CPC G06F 21/105; H04L 63/0435; H04L 63/062; G06F 2221/0704; G06F 2221/0753; G06F 2221/0755

(57) ABSTRACT

In one embodiment, a system comprises: a content provider interface logic to receive a content license from a content provider, the content license to indicate that the system may distribute digital content associated with the content license to one or more devices; an attestation logic to attest a state of a first device; and a key management logic to generate a content key for the first device responsive to a request by the first device for the digital content and attestation of the first device state, and provide the content key to the first device. Other embodiments are described and claimed.

This application claims priority to U.S. Provisional Patent Application No. 62/172,962, filed on Jun. 9, 2015, in the names of Ned M. Smith, Rajesh Poornachandran, and Nathan Heldt-Sheller, entitled PROVIDING PROTECTED CONTENT IN AN IOT NETWORK, the disclosure of which is hereby incorporated by reference.

### BACKGROUND

Increasingly, Internet of Things (IoT) devices have physical capabilities to be consumers of digital rights management/enterprise rights management (DRM/ERM) protected content. For example, smartwatches have displays and 3D printers have license-able object patterns. Many of the IoT products are produced by smaller companies and ‘makers.’ The maker community includes small companies who may be crowd funded and who sell a small number of devices. Consequently they cannot make large investments in DRM licenses. For example, a Microsoft PlayReady license costs approximately $100,000 for a manufacturer's license. This is typical of DRM licensing practices.

As a result, most IoT devices, even though they may have hardened security capabilities (e.g., hardware/firmware/operating system (OS) isolation/virtualization/application containerization), cannot consume high value content due to lack of manufacturer's license. Existing high value content management systems (e.g., DRM) lack the capability to scale and embrace the next generation of IoT devices that often contain content consumption capabilities. For example, IoT devices with content display capabilities are not currently implementing DRM (e.g., PlayReady) schemes for content decode. As examples, real-time stock tickers, real-time scores, etc., are not supported by many current IoT devices.

### BRIEF DESCRIPTION OF THE DRAWINGS

FIG. 1 is a block diagram of a system arrangement in accordance with an embodiment of the present invention.

FIG. 2 is another block diagram of a system arrangement in accordance with an embodiment of the present invention.

FIG. 3 is a flow diagram of an operational flow for control of key management and content distribution within an IoT network as described herein.

FIG. 4 is a block diagram of an example system with which embodiments can be used.

FIG. 5 is a block diagram of a system in accordance with another embodiment of the present invention.

FIG. 6 is a block diagram of a system in accordance with another embodiment of the present invention.

FIGS. A-T are diagrams of interactions in accordance with various embodiments.

### DETAILED DESCRIPTION

Embodiments provide an IoT Key Manager (IKM) that can license DRM and/or other high value content and is authorized to re-distribute such content to devices that meet robustness rules. To this end, the IKM qualifies IoT devices with sufficient security capability and provisions/manages content and content keys dynamically within a given IoT network.

Embodiments identify an IKM device in an IoT network that is manufactured with DRM capabilities (e.g., Microsoft Play Ready). Such capabilities may include presence of hardware, software, firmware and/or combinations thereof that enable permitted handling of DRM content. The IKM is licensed by one or more content providers as a Content Controller, which permits it to distribute high value DRM content. As used herein, “high value DRM content” means any digital content that is desired to be protected from unauthorized access, distribution, copying or so forth through electronic means involving DRM technology. The IKM establishes which IoT devices may satisfy content robustness rules by discovering device capabilities and attesting these capabilities using a device manufacturer certificate, a trusted execution environment (TEE) attestation, or other credential recognized by the IKM as evidence of a trustworthy content display device. If the device can meet required robustness criteria, the IKM uses a given key management capability such as the “Fluffy” key management system (e.g., Fluffy: Simplified Key Exchange for Constrained Environments, draft-hardjono-ace-fluffy-00 (draft IETF Specification Mar. 23, 2015)) to provision a content decryption key.

The IKM is optimized for efficient key management across many IoT devices and supports publish-and-subscribe, multi-cast and unicast variants. By combining content key management with IoT key management, high value content distribution can benefit from an efficient IoT key management infrastructure.

Embodiments thus provide a key management system that enables a key manager to provide key management and digital content management for a plurality of IoT devices. Given that IoT devices can have widely disparate compute and other capabilities (e.g., processing power and/or storage capacity), and may further have multiple dissimilar transport and network technologies, embodiments provide a key management system that can implement symmetric cryptography, asymmetric cryptography, or both to issue both symmetric and asymmetric keys. More specifically, embodiments can enable use of asymmetric keys (such as typically managed using Public Key Infrastructure (PKI)), symmetric keys (such as typically managed using Kerberos), and further enable ad hoc approaches to key management such as using a Diffie-Hellman key agreement to produce symmetric keys.

By further allowing the IKM to attest hardened IoT devices, though possibly not DRM certified, IoT devices may more easily handle high value content. Device specific consumption constraints can be taken into consideration at the time the content is delivered by the IKM. For example, media content can be down-rendered to match IoT device capabilities or multiple IoT devices may be employed to partition a 3D printing job. For example, a streaming media content may be down-rendered in terms of one or more audio tracks, one or more video tracks and video may be further decomposed into RGB streams and pixel depths. As another example, media content's quality metrics can be down scaled (e.g., bit rate, resolution, frame rate, etc.) and appropriate license adjustments can be made. In some scenarios, audio and/or video can be dropped, depending on IoT device capability.

Or a multi-device 3D printing content can be broken into a set of interpretable instructions supplied to an interpreter (e.g., JavaScript, Python, Node.JS, Java) that further reduces to commands given to a 3D printer driver interface. A complex 3D printing task may involve multiple components/parts that together form a mechanical structure (machine) that performs a given function. A decomposition of the printing task may enable multiple 3D printers to each print a different piece of the machine.

Existing IoT devices depend on statically provisioned keys for authenticating device-to-device, and do not have the ability to consume high value content unless provisioned by the manufacturer with a DRM ready key. Embodiments provide an IKM that has the ability to provision and manage the content distributed by a content provider dynamically.

The IKM may obtain a pre-shared key, e.g., via a Diffie-Hellmann exchange process, or device certificate from an on-boarding process in which an IoT device is entered into a given IoT network. This on-boarding process may be used to authenticate each device and attest the device security hardening capabilities and determine if these capabilities satisfy DRM robustness rules, e.g., given device specific content rendering rules. As such, high value content can more easily be consumed on IoT devices; especially where devices are produced by the ‘maker community,’ without requiring maker communities go through the heavy lifting of license acquisition.

By introducing an IKM, a run-time evaluation of an IoT device may enable that device to receive content, when it might not have been authorized at manufacture time. A good example would be dated content (content for which the license changes over time or expires completely). For this content, DRM robustness requirements must be met in order to receive the content in the first place, and evaluate the date restrictions. An IKM could assess the content, determine that the date restrictions have expired, and then distribute the content to a lower-robustness endpoint.

There are a host of small bits of DRM-specific software to handle certain DRM license rules, and which are too numerous to be pre-installed on IoT devices. However an IKM that dynamically manages these software packages can deliver only the packages needed to handle the particular DRM content that is about to be delivered to the IoT device. These packages/capabilities could easily be garbage collected after use to preserve IoT device resources. One example of such software is a dynamic application loader (DAL) applet to be installed on an IoT device based on the content and license to be provisioned for a given session. This applet can complement certain hardware/DRM rendering features on the IoT device at run time (e.g., soft decrypt DAL applet module, soft decode or transcode DAL applet module). These applets can be encrypted (just like the content itself) so that only a targeted IoT device can decrypt, install and execute the applets.

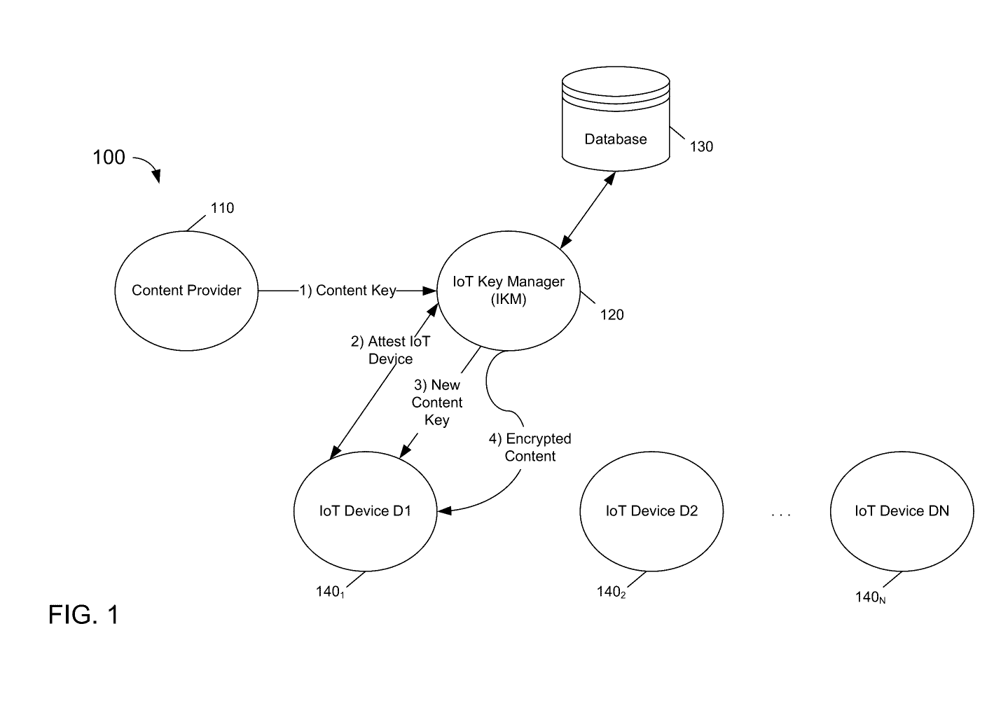

Referring now to FIG. 1, shown is a block diagram of a system arrangement in accordance with an embodiment of the present invention. As shown in FIG. 1, system 100 includes various devices and computing systems that may couple together via any type of computer network, including combinations of local area networks, IoT networks, and wide area networks such as the Internet. As illustrated, system 100 includes a content provider 110. Content provider 110 may be implemented as a collection of one or more server computers and associated storage devices, such as a cloud-based content provider system, e.g., Netflix, Hulu, a Microsoft PlayReady-compatible content provider, and/or any other type of DRM/ERM content provider.

Assume for purposes of discussion that content provider 110 has provided a content license to an IoT key manager (IKM) 120. In an embodiment, the content license includes a content key (which is the key used to encrypt the content) and license restrictions (e.g., number of times the content can be played back, whether a content can be copied from one device to other, key expiration time, device topology rules, etc.). In examples, a content license can be for a specific single content or a group of content (e.g., license to watch all the episodes of “Breaking Bad”).

Key manager 120 itself may be implemented as one or more server computers or other computing devices within an IoT network that have DRM/ERM capabilities. Such server computers may include various hardware logic circuitry to perform key management operations as described herein. In an embodiment, IKM 120 includes a content provider interface logic, an attestation logic, and a key management logic, among other hardware logic. As described further herein, at least the attestation logic and key management logic may be implemented within one or more hardware security processors and/or security engines. Such hardware may execute in a TEE that is isolated from an unprotected operating environment of the system, as implemented by one or more general-purpose processors, e.g., CPUs. Stated another way, this security hardware, the TEE and the DRM/ERM operations described herein are inaccessible to such CPUs.

Content provider 110 supplies high value content to IKM 120 under a content license as a domain controller. Thus content management server 110 authorizes IKM 120 to become a dynamic domain controller to allow provisioning and content sharing across ad hoc extended clients located in an IoT network. IKM 120 is manufactured to meet domain controller hardening requirements. In addition, IKM 120 may further handle key management activities on behalf of devices within the IoT network. As will be described herein, IKM 120 may be configured to manipulate protected digital content in a manner to enable downstream IoT devices, namely IoT devices 140₁-140ₙ, to receive and consume the digital content. This is the case, even though devices 140 may not have at least certain compute capabilities and further may lack any direct content license from content provider 110.

In embodiments, IKM 120 may be of a given domain, and can be designated, e.g., by one or more content providers, as a domain controller. IKM 120 may be a simple key distribution center (SKDC) to interact with IoT devices 140. In some embodiments, IKM 120 may be a key manager in accordance with the Fluffy key management system (see https://datatracker.ietf.org/doc/draft-hardjono-ace-fluffy/for version 01) that defines intra-group key management primitives such as formation and scheme. This enables key lifecycle management that is common across multiple key types and contexts including key management for groups involving protected content.

IKM 120, alone or in connection with an on-boarding tool or other network entity, may bootstrap an IoT network using both ad hoc and third party introduction techniques. When an IoT device 140 is introduced, an ad hoc key management process may be performed to provide one or more keys (a symmetric key, an asymmetric key, or both) to the device in a key management context structure. This ad hoc key establishment may occur via a Diffie-Hellman key exchange, or the like.

In an embodiment based on the Fluffy key management system, IoT devices 140 may be introduced to the domain to which IKM 120 is the domain controller by sending a request “PSK-REQ” to IKM 120 for a ticket. As used herein, an example of a “request” and a “reply” includes “GSK-REQ”/“PSK-REQ” and “GSK-REP”/“PSK-REP”, however “GSK-FET”/“PSK-FET” may also be considered a request and “GSK-DEL”/“PSK-DEL” may also be considered a reply. Further details regarding such requests and replies are located at, for example, https://tools.ietf.org/id/draft-hardjono-ace-fluffy-00***txt (see also (see ***https://datatracker.ietf.org/doc/draft-hardjono-ace-fluffy/ for version 01). The reply to such a request may use a client permissions field (cpac: the permissions and access control (PAC) structure containing permissions granted to a client associated with a key enclosed in receipt sent to the client).

In some cases, IKM 120 may receive content from content provider 110 that it may further render to meet device specific constraints for content consumption. IKM 120 may enlist the help of a content rendering service to offload the rendering load. In such cases, the content rendering service may be required to meet robustness requirements. As further illustrated in FIG. 1, IKM 120 is coupled to a database 130. In various embodiments, database 130 may store, inter alia, key management information associated with IoT devices 140.

FIG. 1 further shows a flow of operation to enable secure digital content to be handled within system 100 and provided to IoT devices 140. Specifically, content provider 110 provides a content key to IKM 120. In various embodiments, this content key may be provided as part of a content license that indicates that IKM 120 may operate as a domain controller. The license establishes that the device is authorized by a manufacturer to install the content provider's credential in the device at manufacturing time. This key is used to encrypt content keys that are specific to a content delivery. Still further, this content license may indicate that IKM 120 is authorized to attest to certain device hardening requirements of downstream IoT devices 140, and if such requirements are met, enable provision of protected digital content to such devices for consumption. In one embodiment, IKM 120 is factory provisioned with one or more DRM licenses authorized as a content controller that may act as key management proxy for IoT devices 140.

Thus as illustrated further in FIG. 1, an attestation may occur between IKM 120 and a given IoT device 140₁. Understand that this attestation may occur as part of a key management request by IoT device 140₁ for provision of a content key to decrypt protected digital content, e.g., a movie or program advertised as being available through IKM 120. In an embodiment, content availability may be advertised using a publish-subscribe system such as Jabber or BitTorrent where a content title is registered in the publish-subscribe system and where subscribers are able to peruse a directory to discover (and subscribe to) new content streams. Understand that while the attestation process may occur in different manners, in some embodiments the attestation process may cause IoT device 140₁ to provide a manufacturer certificate, implemented within IoT device 140₁ during its manufacturing, that indicates that IoT device 140₁ has particular security-based capabilities, including the capability for a trusted execution environment. IoT device manufacturers implement their own IoT manufacturer certificates. For example, the Trusted Computing Group (TCG) and Intel® Manageability Engine (ME) define manufacturer certificate formats for attestation, which may be provisioned into IoT devices 140 during factory provisioning.

IKM 120 may require IoT devices 140 attest using a manufacturer certificate to discover that it satisfies DRM robustness rules. IKM also captures device attribute information including device capabilities that prescribe limitations to content consumption. For example, such capabilities may include dimensions of a display peripheral and whether HD, SD, sound-only, text subtitles, content metadata or other constraints should be applied. IKM 120 exposes the current downstream devices and their provisioned capability to render the content and their capabilities to enforce DRM robustness rules. Typically an IoT network may use two types of discovery: IP multi-cast or a directory service. Devices that are available for interaction with other devices will respond to broadcasts requesting device discovery (or will populate an entry in a directory service that allows this device contact information to be known, e.g., an IP address and port number). Sleeping devices may also include information for poking a wake signal to the devices' network interface. As per the license IKM 120 receives from content provider 110, it may have to disclose the downstream devices it is supporting for content/license distribution, so that IKM 120 would expose the discovered information to the content provider. A (new) content key is distributed to the IoT device conditioned on meeting robustness rules.

Assuming that appropriate security requirements (as indicated by content provider 110) are met based at least in part on this certificate or other attestation information, IKM 120 may enable IoT device 140₁ to be authorized as a content consumption device. In an embodiment, the attestation information may include: existence of and type of trusted execution environment technology; software running on the TEE (version, manufacturer); device vendor/make/model/version; security hardening criteria (e.g., FIPS/Common Criteria score); content handling capability (HD, SD, display capabilities); any sub-downstream devices that the IoT device is connected with; audio/video/display topology metrics; and TEE's capability to infer content consumption analytics.

Still with reference to FIG. 1, next responsive to determination of the capabilities of IoT device 140₁, a new content key can be generated in IKM 120, assuming that IoT device 140₁ meets appropriate robustness rules. In some embodiments, this content key may be a group (shared) content key where multiple devices concurrently consume the same content via a multi-cast communication channel. Note that in some cases this multi-cast content communication may be performed by IKM 120 directly, while in other case a broker service may perform this communication, either via multi-cast or a series of unicast messages. In this or other embodiments, this content key may include pair-wise symmetric key distributions and provisioning of public keys for use to verify a device-embedded private key.

Responsive to providing this content key to IoT device 140₁, given requested protected content received from content provider 110 may be provided from IKM 120 as encrypted content to IoT device 140₁. IKM 120 performs a key management function where it distributes the content key to a vetted IoT device. Content need not be decrypted then re-encrypted if the IoT device has sufficient display capabilities to accept the content directly. Or IKM 120 may determine that down-rendering is to be performed and will decrypt the high value content to better match the display capabilities of IoT device 140, and then re-encrypt either using the original content key or by generating a new content key that is shared with IoT device 140₂ according to the Fluffy protocol. Based on the modification IKM 120 has done to the content, it may derive the appropriate license to be enforced by a TEE of IoT device 140 for content consumption.

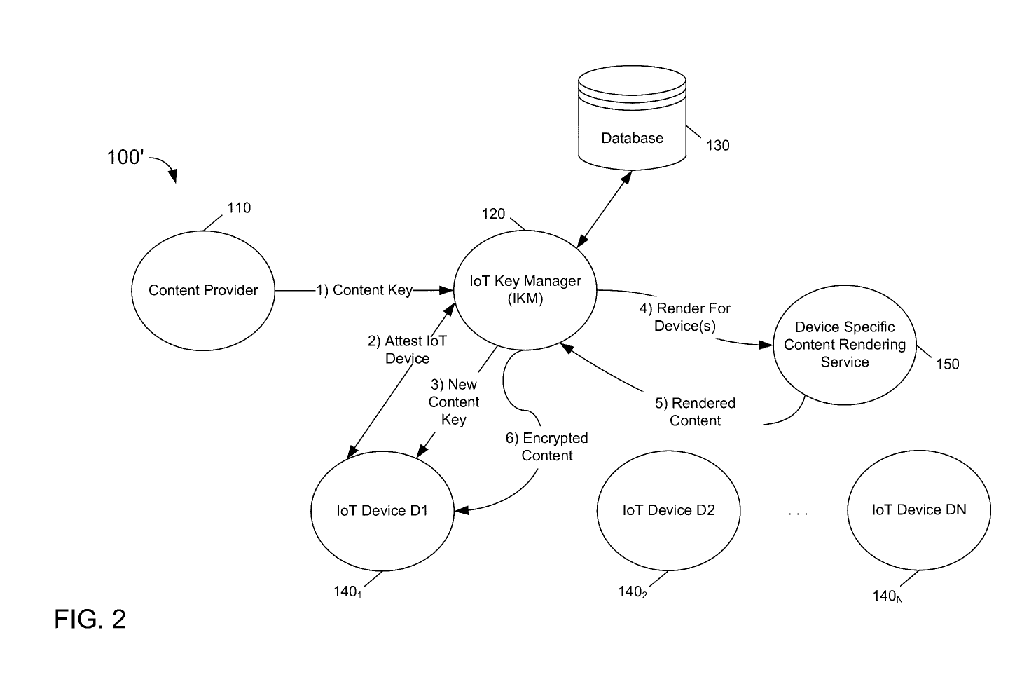

In turn, IoT device 140₁ may decrypt and render such content to enable its consumption (e.g., display) on IoT device 140₁. The provided content key, which may be a particular device-specific key for IoT device 140, or a group key for an IoT group of which device 140₁ is a part, may be used to decrypt the received encrypted content. Understand that in some cases, a given IoT device 140 may not have sufficient compute or other capabilities to perform content rendering. In such cases, IKM 120 or another entity may perform content rendering on behalf of IoT device 140₁. Such operation is described further below with regard to FIG. 2. Use of a content rendering service may require transmission and protection of the content key to the rendering service or re-encryption using pair-wise channel encryption such as datagram transport layer security (DTLS), TLS or Internet protocol security (IPSEC).

An IoT Content Consumption Device (CCD) performs detailed attestation with the IKM during device on-boarding or when the CCD attempts to obtain a content key (e.g. Kerberos ticket/fluffy mini-ticket) using the manufacturers certificate(s). The CCD convinces the IKM about its trustworthiness to consume DRM content by disclosing platform hardening assurances applied during manufacturing (e.g., TCG platform certificate) and IoT device operational considerations, including key storage mechanism, trusted execution environment (TEE), secure boot, trusted update etc. In a scenario where the IoT device hardware and runtime are capable of supporting DRM robustness requirements, but the IoT device does not have the necessary software to receive DRM content (e.g., a DRM-specific key derivation protocol, or DRM-specific attestation capabilities) the on-boarding process may include provisioning the IoT device with the necessary software to meet DRM requirements. This additional capability provisioning could also take place at a later step, for example, during IKM/IoT device management ticket installation.

In an embodiment, content provider 110 and IKM 120 create a key management ticket that contains: i) dynamic provisioning for the downstream CCDs, and ii) shared copies of content/content key authorized for a limited time to a specific (named) set of consumer downstream devices managed by IKM 120. Depending on the dynamic trustworthiness of an IKM, ticket/policy constraints can be determined by content provider 110. Based on the outcome of the attestation, IKM performs: dynamic secure provisioning of CCDs in the network using the ticket and locks them; and shares content/license constraints based on the CCD supported security level.

IoT devices 140 may follow an on-boarding process (e.g., Open Interconnect Consortium—OIC) where an IoT network management tool may be used to ‘take ownership’ of the device as part of device on-boarding. A consequence of device ownership is the device self-selects a random device ID and one or more device keys may be bound to this deviceID. A network management tool, which may be implemented as part of IKM 120 or as a separate server/servers, produces a database of keys and device IDs of ‘owned’ devices. The complete database of owned devices (with keys) may be available to IKM 120, e.g., via database 130, to authenticate the devices using an ID and key that is specific to the on-boarding network. This enables IKM 120 to reliably authenticate member devices that need content consumption keys assigned by IKM 120. If an IoT device leaves the network, then it may be marked in database 130 as removed, thereby preventing it from obtaining a next content ticket. This alleviates a huge performance concern that attestation may be applied at each ticket request, though this could be applied if heightened security conditions exist.

As an example, one way to map DRM rules and a content key into a Fluffy ticket structure is: Ticket.key=device specific content key or group specific content key; Ticket.pac=DRM rules, enforced by the IOT device expressed as OIC access control lists (ACLs) or as PlayReady rules, assuming the IoT device has a PlayReady parser/application, or both in some embodiments.

Referring now to FIG. 2, shown is a block diagram of a system in accordance with another embodiment of the present invention. In the embodiment of FIG. 2, system 100′ may be configured substantially the same as in FIG. 1. However, note the presence of a separate content rendering service 150. In various embodiments, content rendering service 150 may be implemented as one or more server computers. To this end, in embodiments content rendering server 150 may include content rendering logic, which may be implemented as hardware circuitry, software and/or firmware and/or combinations thereof, to perform content rendering on behalf of IoT devices 140, e.g., when such devices lack capabilities for performing content rendering. Although shown in this particular implementation, understand that in another case, such content rendering service 140 may be implemented as part of IKM 120.

As further illustrated in FIG. 2, the flow of operation is substantially the same as in FIG. 1. However, note that responsive to a determination that a given IoT device 140 does not have appropriate content rendering capability, a communication may occur between IKM 120 and content rendering service 150 to provide the requested content, to enable content rendering service 150 to appropriately render the content, and provide the rendered content back to IKM 120. In turn, IKM 120 may, e.g., encrypt the rendered content and provide the encrypted rendered content to requesting IoT device 140. Note that in other cases, communication of rendered content (e.g., in an encrypted format) may be directly from content rendering service 150 to IoT device 140.

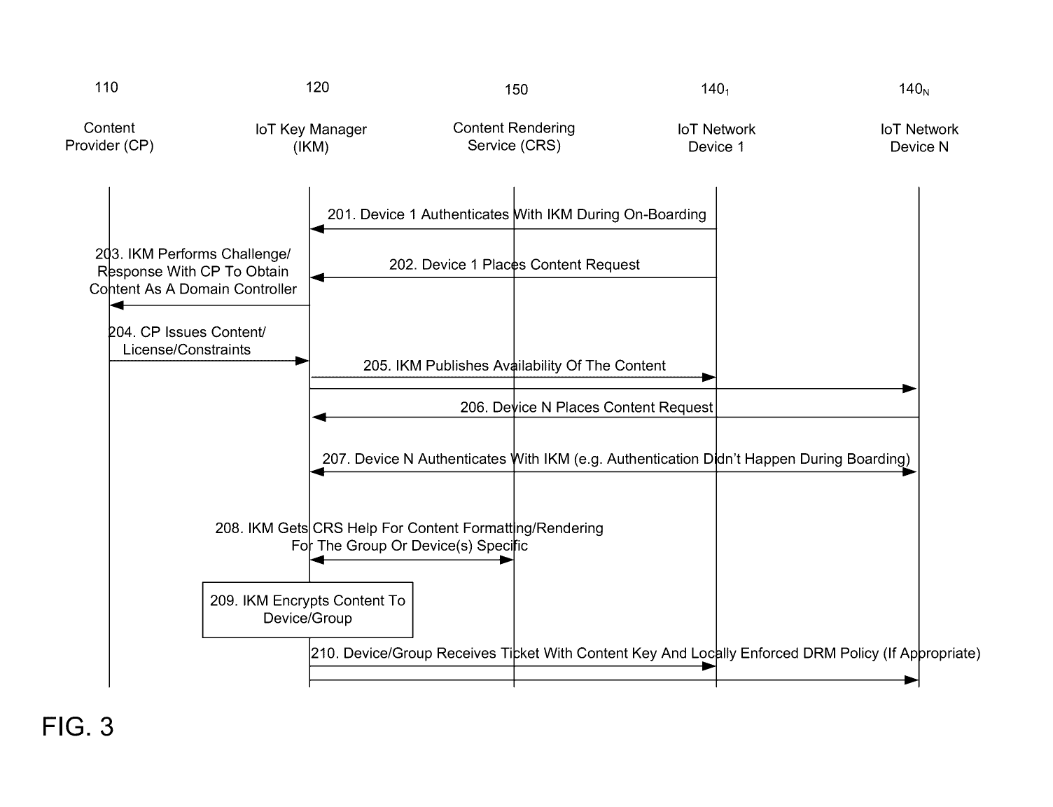

Referring now to FIG. 3, shown is a flow diagram of an operational flow for control of key management and content distribution within an IoT network as described herein. As illustrated in FIG. 3, method 200 provides for interaction between a variety of different systems, including a content provider 110, an IKM 120, a content rendering service 150 and one or more IoT devices 140₁-140ₙ. As shown in FIG. 3, component interaction includes the following: an un-provisioned IoT device 140₁ performs a detailed authentication with IKM 120 during on-boarding; IoT device 140₁ wants to play a specific content of interest, and so places a content access request with IKM 120; IKM 120 obtains license from content provider (CP) 110 as a domain controller; CP 110 issues license/content with associated constraints; IKM 120 publishes the availability of the content to downstream devices. As an example, IoT device 140_{N} requests access to content (authenticates to IKM) 120. IKM 120 collects device attestation (e.g., if not already in on-boarding database); IKM 120 renders (with help of content renderer service 150) device specific or group specific content; IKM 120 encrypts content to device/group; and device/group receives a ticket with a content key and content and locally enforced DRM policy, if appropriate.

Understand that the interaction between devices shown in FIG. 3, while proceeding in a particular order for purposes of discussion, may occur in other another order or with additional (and/or different operations), in other embodiments.

As illustrated, method 200 begins when a given IoT device (e.g., IoT device 140₁) authenticates with IKM 120 (process 201). Such authentication may occur during an on-boarding process in which IoT device 140₁ is introduced into an IoT network. In other cases, this device authentication may occur when an IoT device 140 desires to obtain protected content, as advertised. In any event, at process 202 device 140₁ places a content request. In an embodiment, this request may be responsive to user selection of a desired content from a list of available content of content provider 110.

Responsive to this content request, IKM 120 enters into an authentication protocol with content provider 110 (process 203). More specifically, a challenge-response protocol may be performed to enable IKM 120 to obtain the requested content and to act as a domain controller within an IoT network with regard to this content. At the conclusion of this negotiation process 203, at process 204 IKM 120 may receive the requested content, which is received as protected digital content, along with a content license. In various embodiments, this content license may include a content (e.g., decryption) key, along with various constraints associated with the content. Such constraints may indicate various security policies that IKM 120 is to enforce with regard to the content, such as indicating particular devices or classes of devices (and their capabilities) to which the content may be provided in a sub-licensed manner.

At process 205, the IKM may publish availability of this content. In an embodiment, IKM 120 may issue a publication message within the IoT network. Such publication message may be issued according to a publication-subscription model in some embodiments.

Still with reference to FIG. 3, next at process 206 IoT device 140ₙ issues a request for this content. Then at process 207, IKM 120 may perform an authentication with this device. Understand that in this example, it may be assumed that IoT device 140ₙ did not previously authenticate with IKM 120, e.g., during an on-boarding process.

Still referring to FIG. 3, next at process 208, IKM 120 may interact with a content rendering service 150 to perform appropriate content rendering. Understand that process 208 may be optional. For example, in some cases, one or more IoT devices 140 may have sufficient resources to perform content rendering itself and as such, process 208 may be avoided, at least for such devices. Nevertheless, at process 208 interaction between IKM 120 and content rendering service 150 may occur to enable appropriate rendering and/or formatting of content for particular IoT devices 140. Such rendering/formatting may include, in an embodiment formatting the content for a particular display of an IoT device, e.g., having a particular frame size, frame rate or so forth, among other examples.

Next at process 209, IKM 120 may encrypt the content (either already rendered/formatted or unmodified) to a given device/group. Finally, at process 210, IKM 120 may issue the content, along with an appropriate content key and any security policy information. In one embodiment, IKM 120 may issue a ticket having the content key, along with the DRM policy.

An IoT optimized key management service (IKM) may be configured to be a DRM domain controller that may also attest IoT devices using manufacturer-supplied platform certificates where the IKM establishes whether the IoT device may receive a form of high value content suitable for consumption by the IoT device. Content may be rendered according to device specific constraints.

Embodiments further provide an IoT device ownership protocol and utility/service that transitions a device ownership status from manufacturer owned or ‘unowned’ to an ‘owned’ state that includes associating a cryptographic key (symmetric/asymmetric) to a device ID that is newly generated during device on-boarding. An attestation of the device may assess security properties as part of on-boarding.

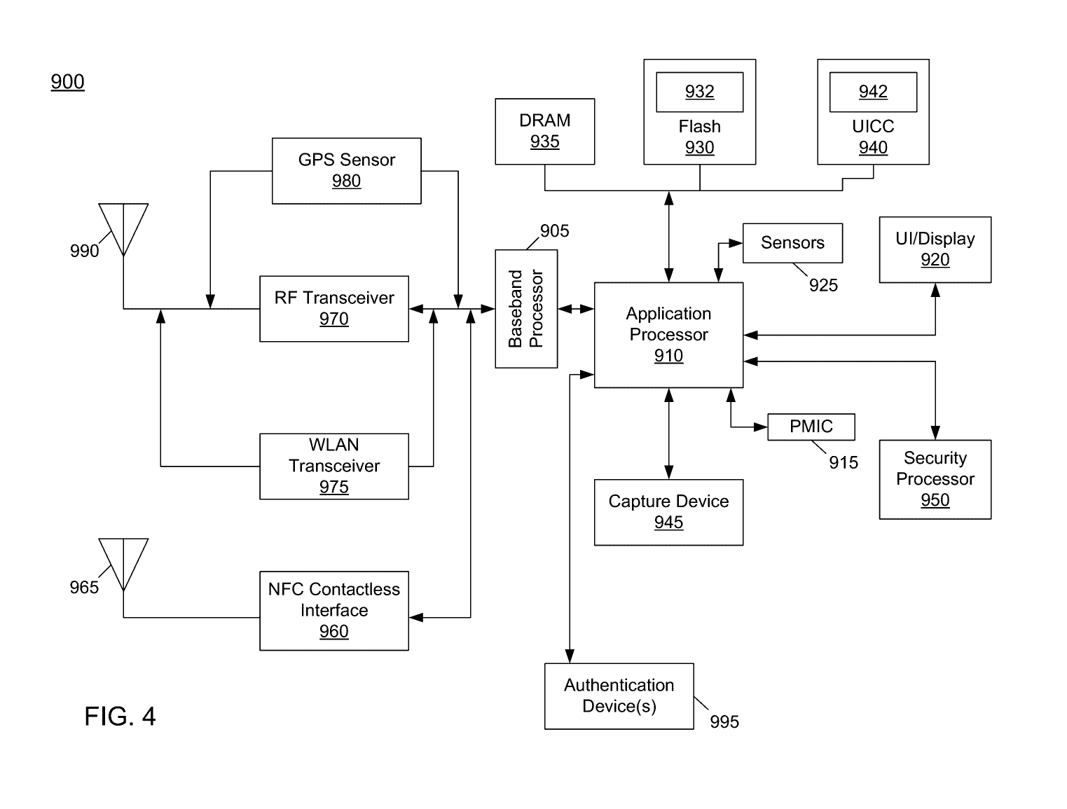

Referring now to FIG. 4, shown is a block diagram of an example system with which embodiments can be used. As seen, system 900 may be a smartphone or other wireless communicator or any other IoT device. A baseband processor 905 is configured to perform various signal processing with regard to communication signals to be transmitted from or received by the system. In turn, baseband processor 905 is coupled to an application processor 910, which may be a main CPU of the system to execute an OS and other system software, in addition to user applications such as many well-known social media and multimedia apps. Application processor 910 may further be configured to perform a variety of other computing operations for the device.

In turn, application processor 910 can couple to a user interface/display 920, e.g., a touch screen display. In addition, application processor 910 may couple to a memory system including a non-volatile memory, namely a flash memory 930 and a system memory, namely a DRAM 935. In some embodiments, flash memory 930 may include a secure portion 932 in which secrets and other sensitive information may be stored. As further seen, application processor 910 also couples to a capture device 945 such as one or more image capture devices that can record video and/or still images.

Still referring to FIG. 4, a universal integrated circuit card (UICC) 940 comprises a subscriber identity module, which in some embodiments includes a secure storage 942 to store secure user information. System 900 may further include a security processor 950 that may that may implement a trusted execution environment (TEE), and which may couple to application processor 910. Furthermore, application processor 910 may implement a secure mode of operation, such as Intel® SGX to a given instruction set architecture, and circuitry for hosting of a TEE. Security processor 950 and/or application processor 910 may be configured to be a downstream content consumption device by way of dynamic interaction with an IKM, as described herein. A plurality of sensors 925, including one or more multi-axis accelerometers may couple to application processor 910 to enable input of a variety of sensed information such as motion and other environmental information. In addition, one or more authentication devices 995 may be used to receive, e.g., user biometric input for use in authentication operations.

As further illustrated, a near field communication (NFC) contactless interface 960 is provided that communicates in a NFC near field via an NFC antenna 965. While separate antennae are shown in FIG. 4, understand that in some implementations one antenna or a different set of antennae may be provided to enable various wireless functionality.

A power management integrated circuit (PMIC) 915 couples to application processor 910 to perform platform level power management. To this end, PMIC 915 may issue power management requests to application processor 910 to enter certain low power states as desired. Furthermore, based on platform constraints, PMIC 915 may also control the power level of other components of system 900.

To enable communications to be transmitted and received such as in one or more IoT networks, various circuitry may be coupled between baseband processor 905 and an antenna 990. Specifically, a radio frequency (RF) transceiver 970 and a wireless local area network (WLAN) transceiver 975 may be present. In general, RF transceiver 970 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 980 may be present, with location information being provided to security processor 950 for use as described herein when context information is to be used in a pairing process. Other wireless communications such as receipt or transmission of radio signals, e.g., AM/FM and other signals may also be provided. In addition, via WLAN transceiver 975, local wireless communications, such as according to a Bluetooth™ or IEEE 802.11 standard can also be realized.

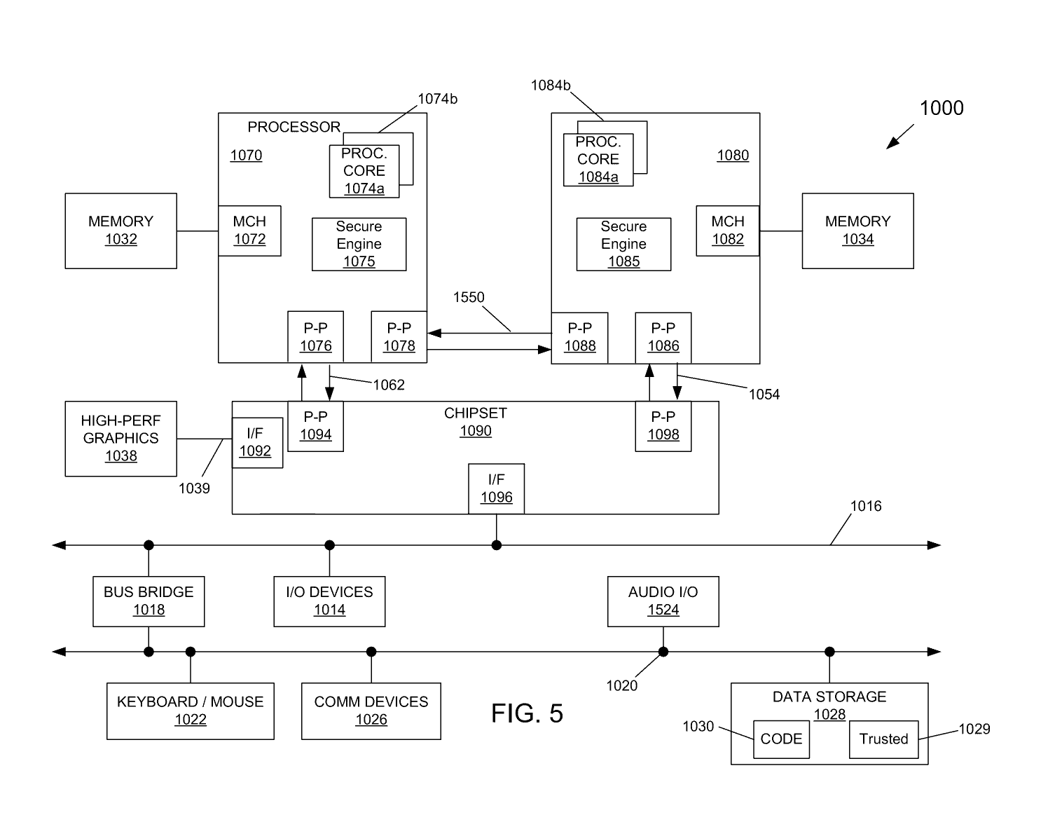

Referring now to FIG. 5, shown is a block diagram of a system in accordance with another embodiment of the present invention. As shown in FIG. 5, multiprocessor system 1000 is a point-to-point interconnect system such as a server system, and includes a first processor 1070 and a second processor 1080 coupled via a point-to-point interconnect 1050. As shown in FIG. 5, each of processors 1070 and 1080 may be multicore processors such as SoCs, including first and second processor cores (i.e., processor cores 1074a and 1074b and processor cores 1084a and 1084b), although potentially many more cores may be present in the processors. In addition, processors 1070 and 1080 each may include a secure engine 1075 and 1085 to perform security operations such as attestations, IoT network onboarding, and DRM key management operations as described herein, or so forth.

Still referring to FIG. 5, first processor 1070 further includes a memory controller hub (MCH) 1072 and point-to-point (P-P) interfaces 1076 and 1078. Similarly, second processor 1080 includes a MCH 1082 and P-P interfaces 1086 and 1088. As shown in FIG. 5, MCH's 1072 and 1082 couple the processors to respective memories, namely a memory 1032 and a memory 1034, which may be portions of main memory (e.g., a DRAM) locally attached to the respective processors. First processor 1070 and second processor 1080 may be coupled to a chipset 1090 via P-P interconnects 1052 and 1054, respectively. As shown in FIG. 5, chipset 1090 includes P-P interfaces 1094 and 1098.

Furthermore, chipset 1090 includes an interface 1092 to couple chipset 1090 with a high performance graphics engine 1038, by a P-P interconnect 1039. In turn, chipset 1090 may be coupled to a first bus 1016 via an interface 1096. As shown in FIG. 5, various input/output (I/O) devices 1014 may be coupled to first bus 1016, along with a bus bridge 1018 which couples first bus 1016 to a second bus 1020. Various devices may be coupled to second bus 1020 including, for example, a keyboard/mouse 1022, communication devices 1026 and a data storage unit 1028 such as a non-volatile storage or other mass storage device. As seen, data storage unit 1028 may include code 1030, in one embodiment. As further seen, data storage unit 1028 also includes a trusted storage 1029 to store sensitive information to be protected. Further, an audio I/O 1024 may be coupled to second bus 1020.

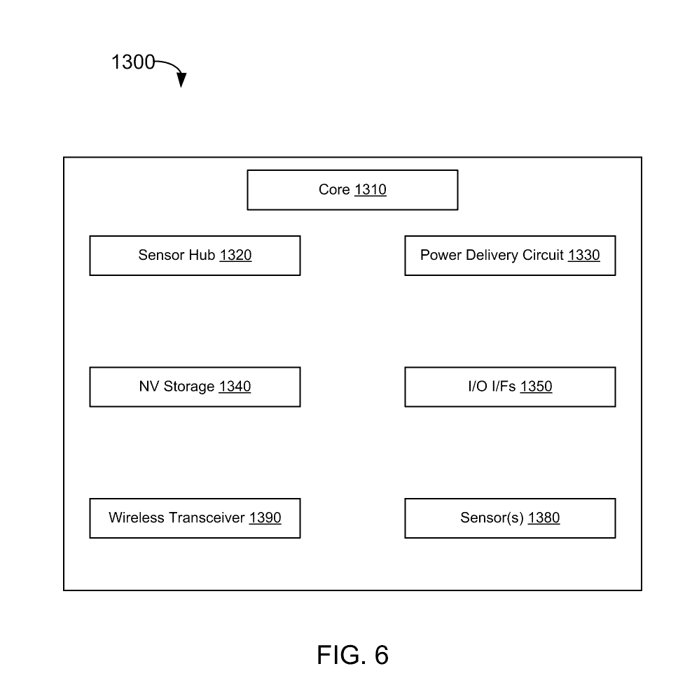

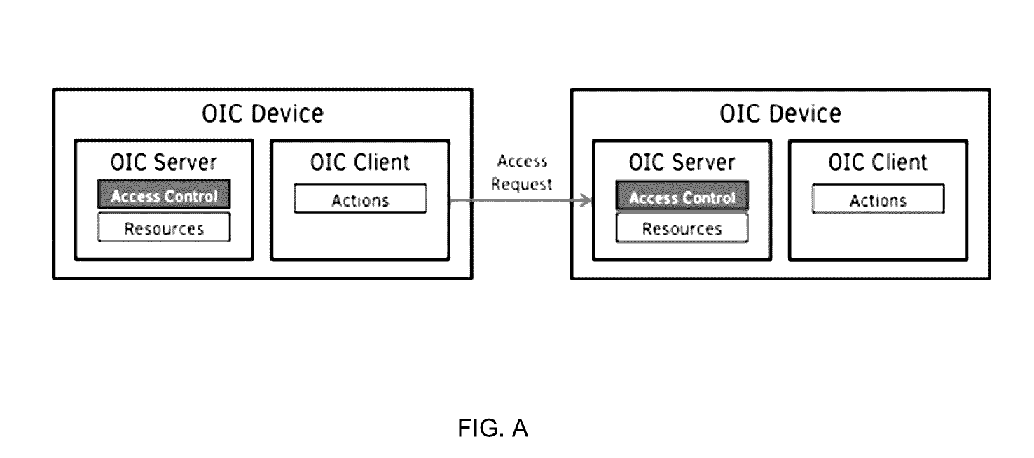

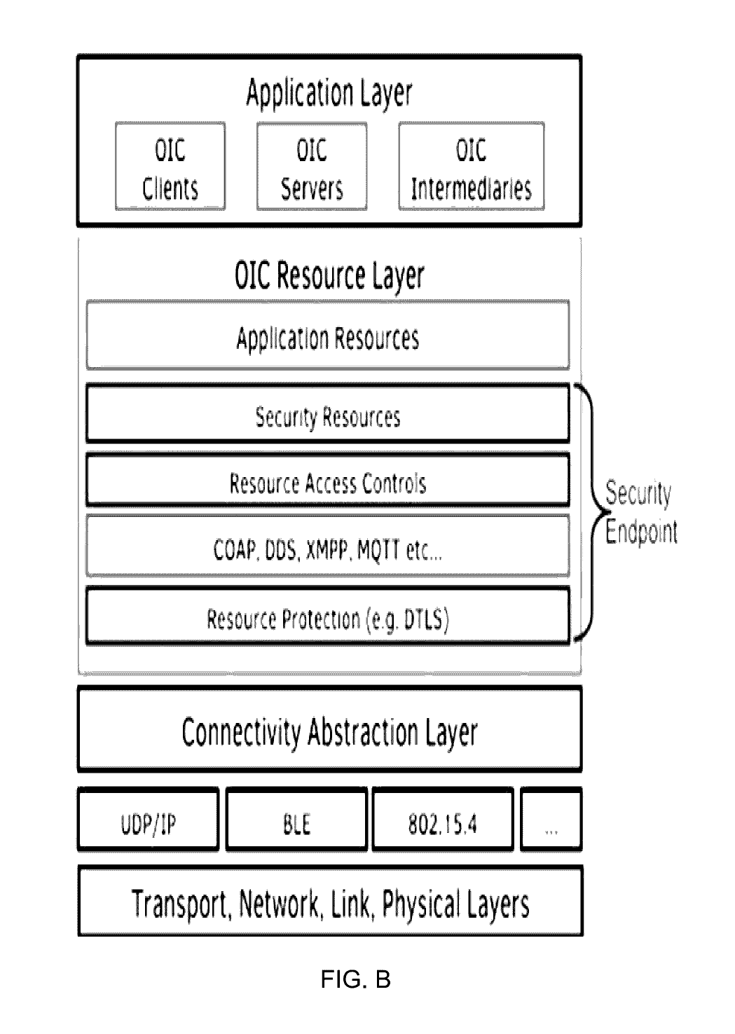

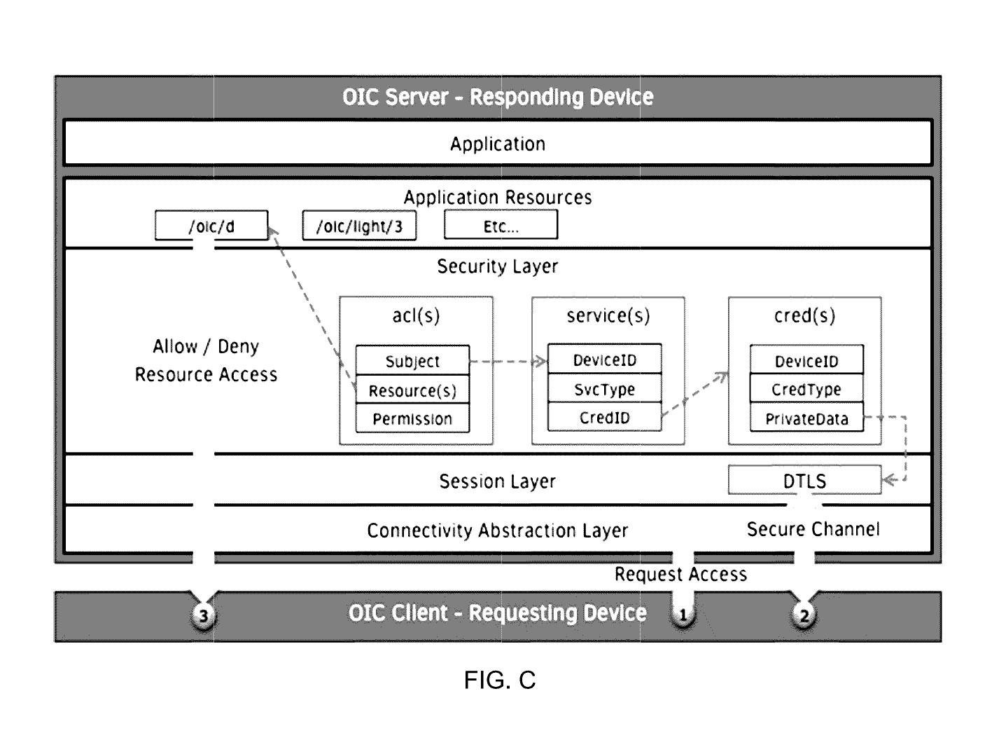

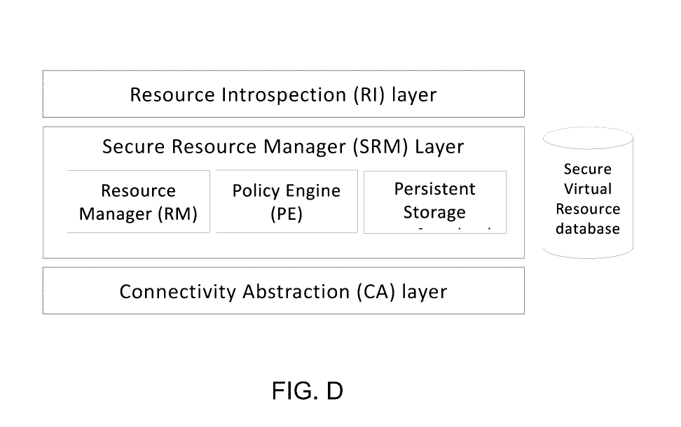

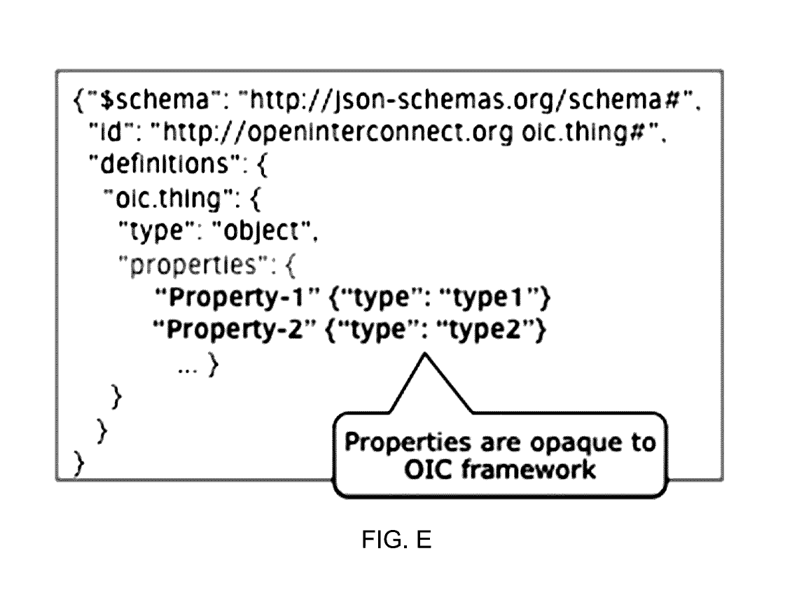

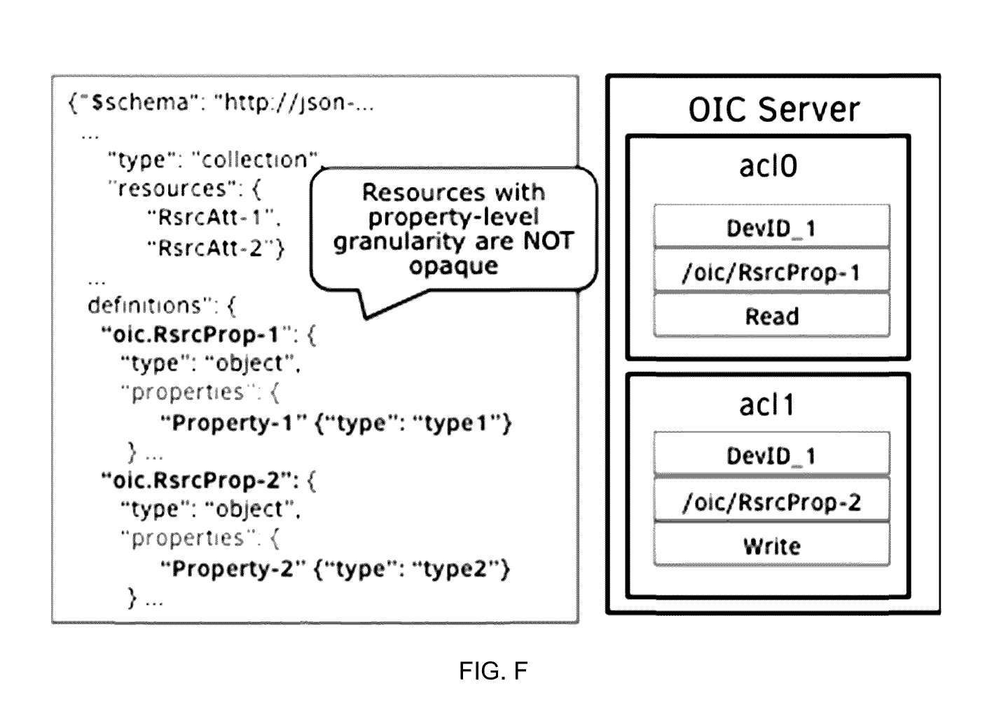

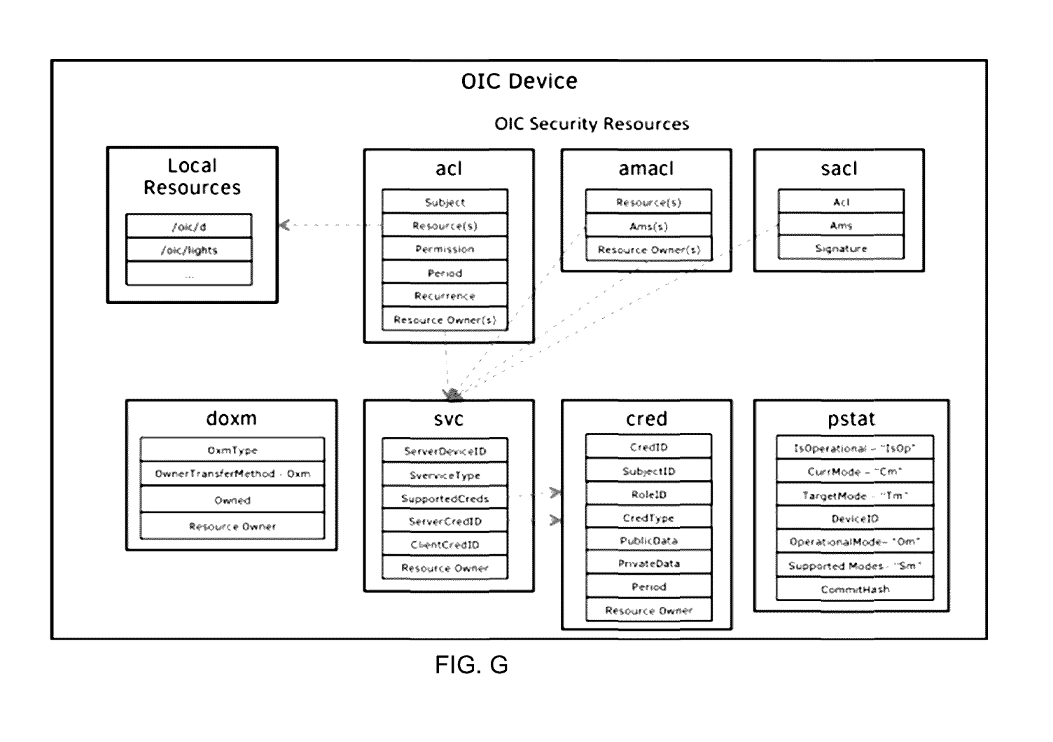

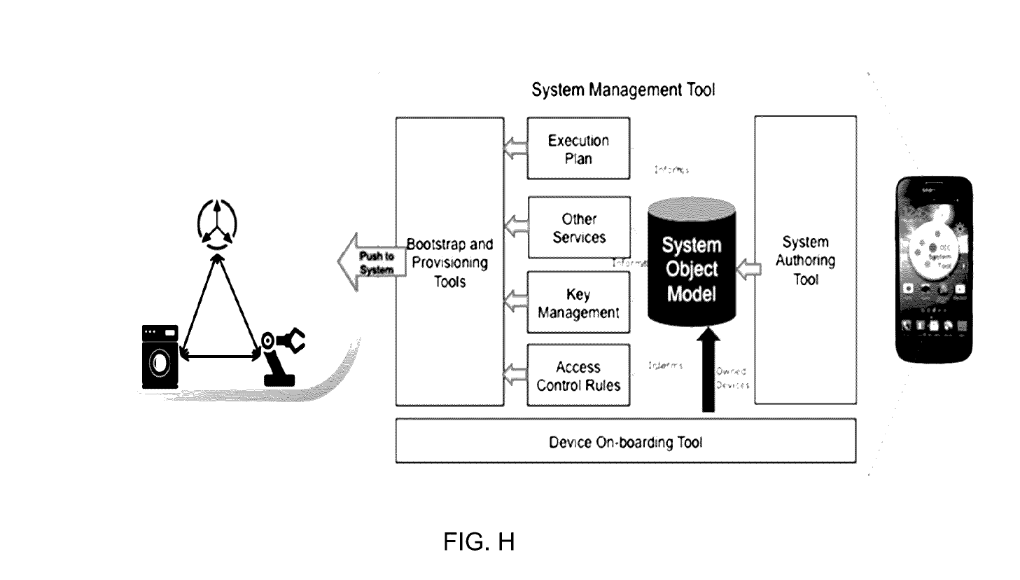

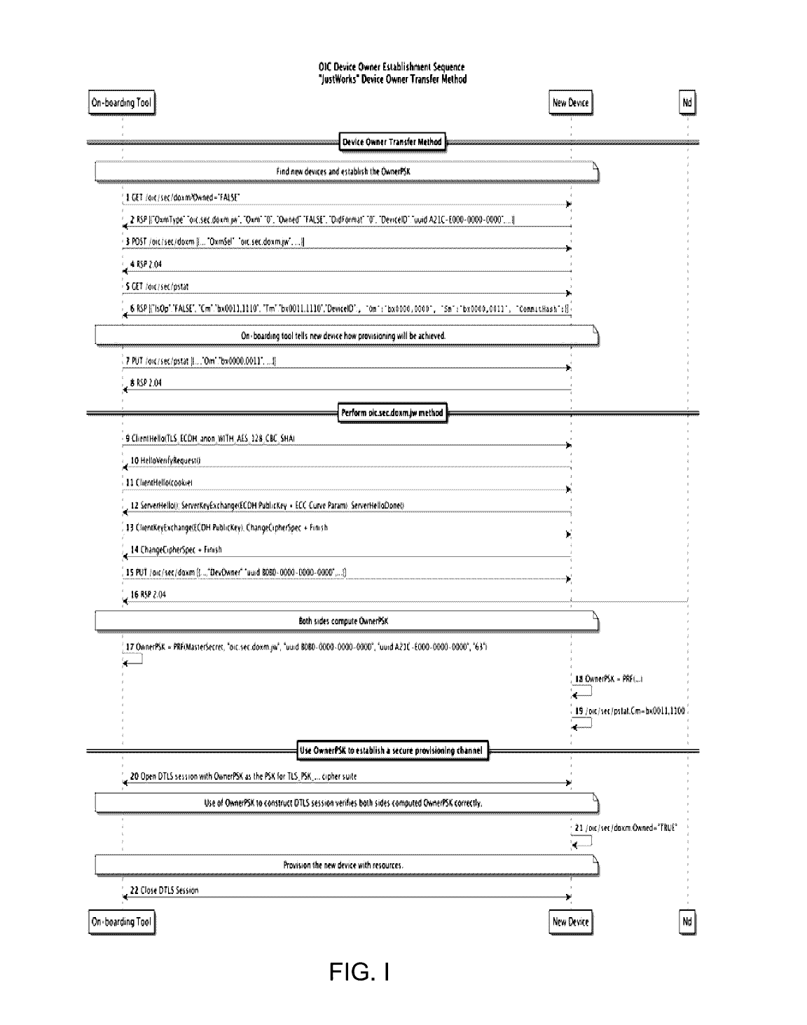

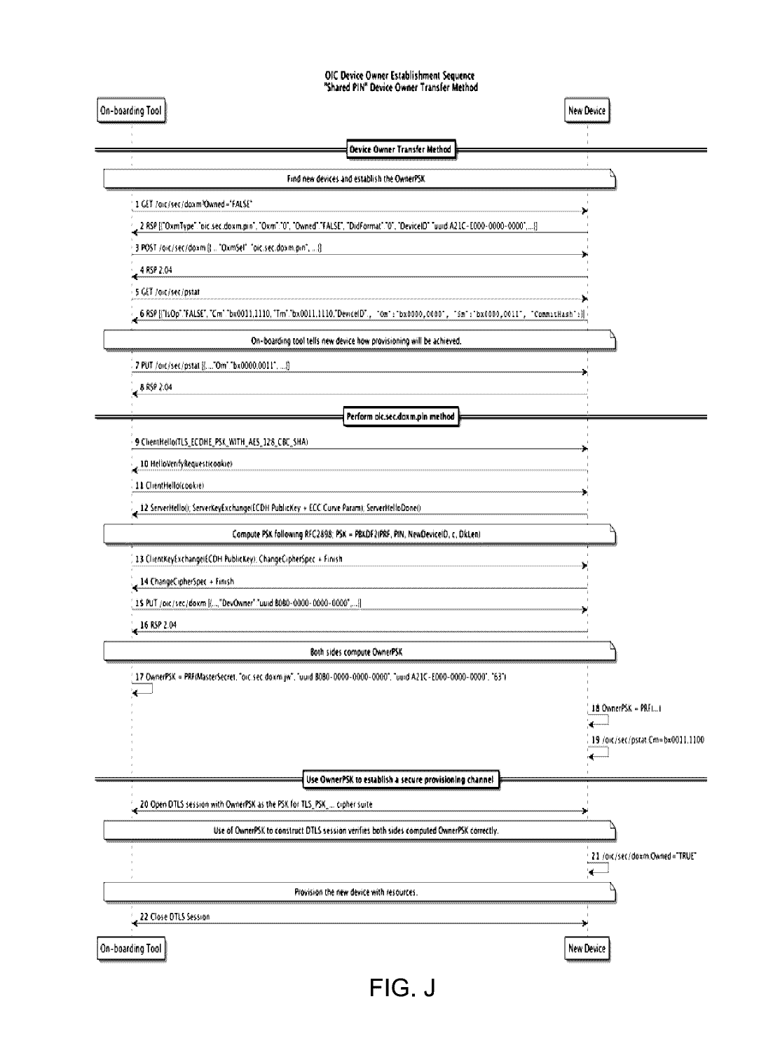

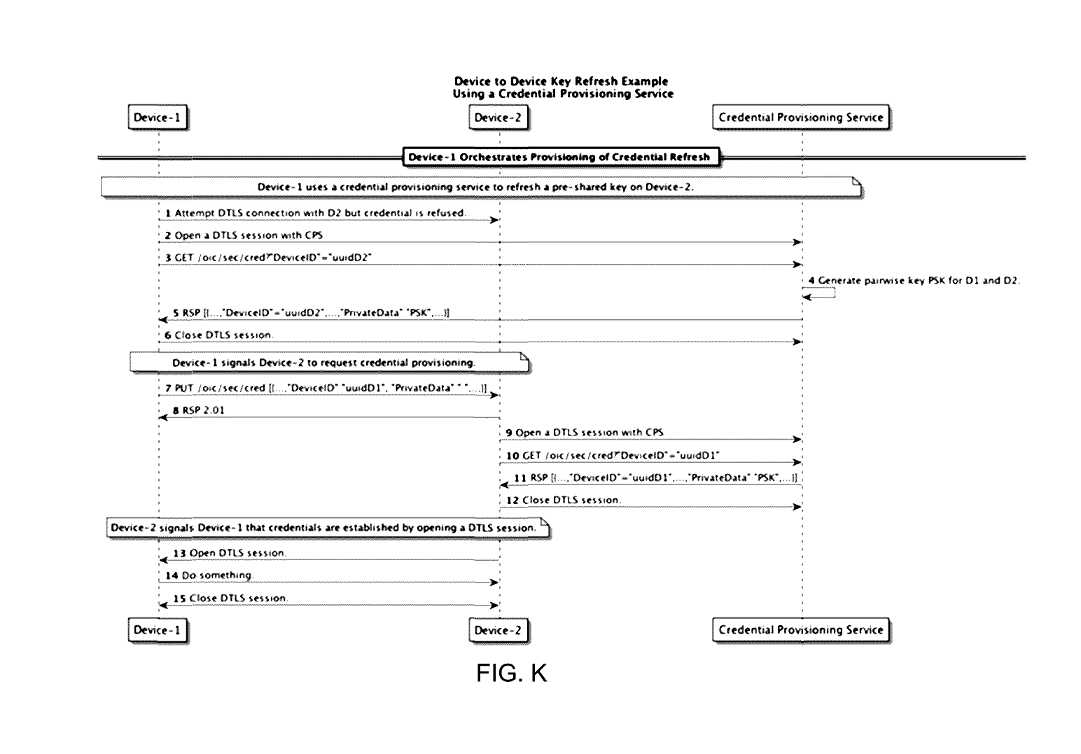

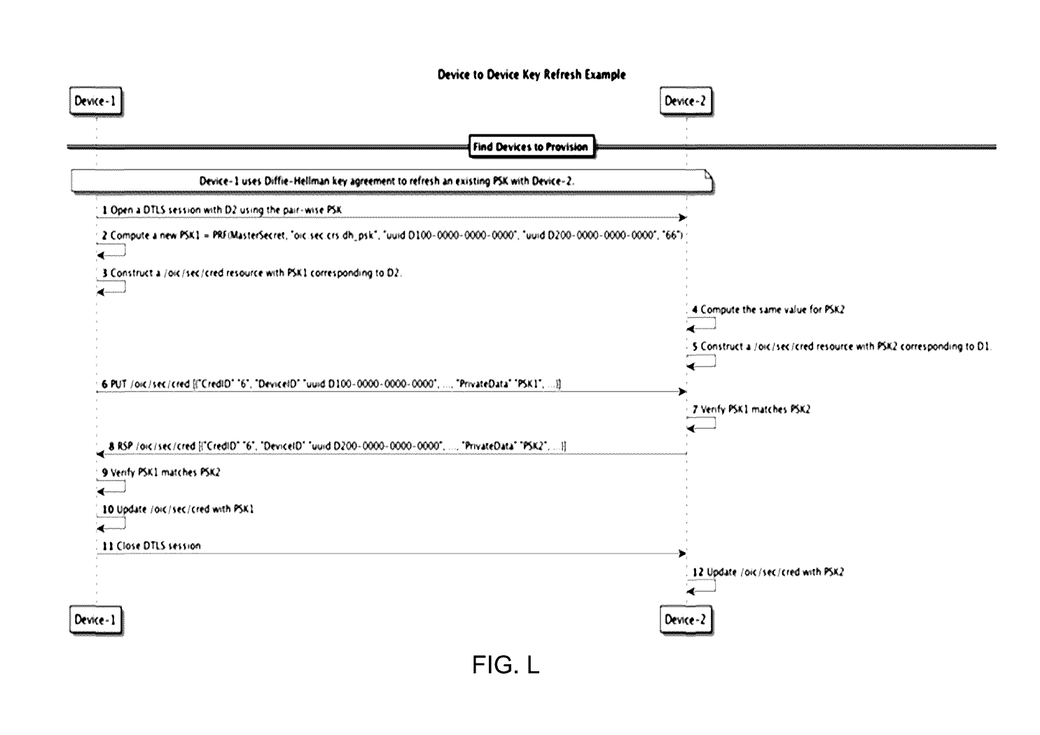

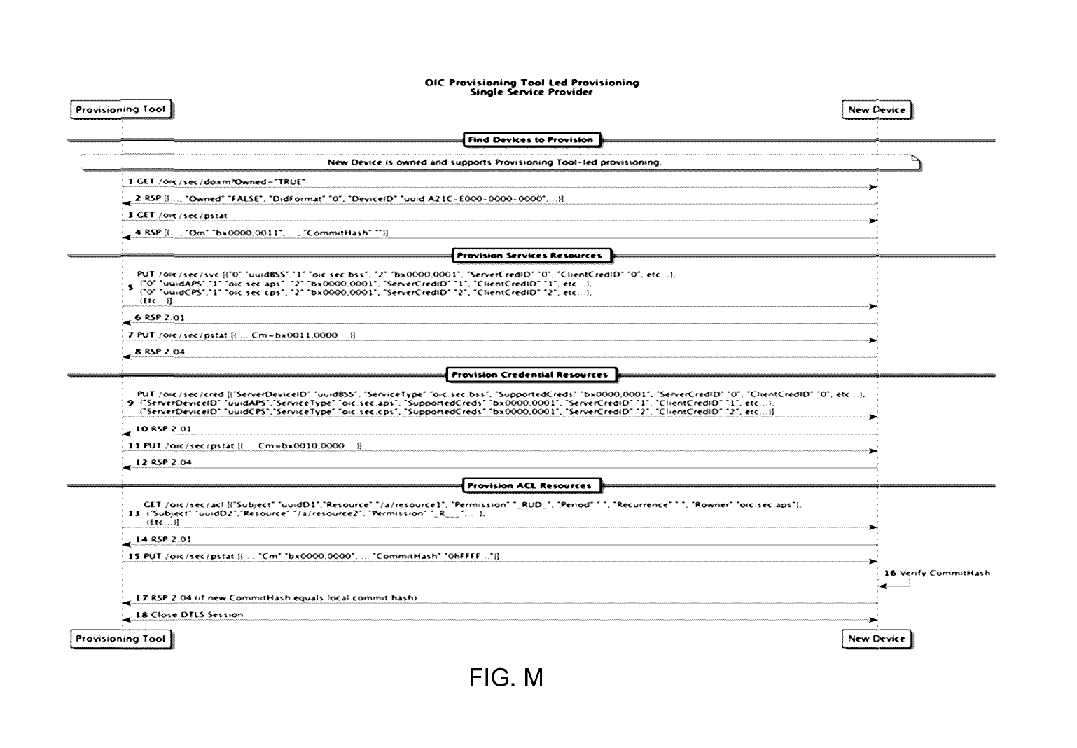

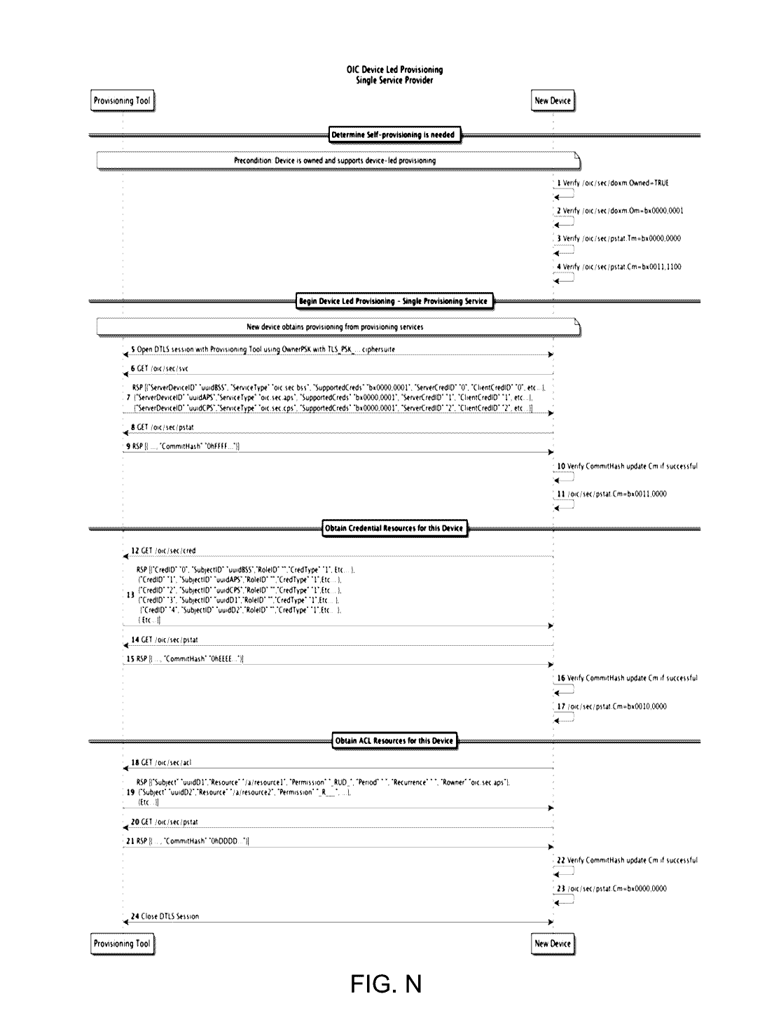

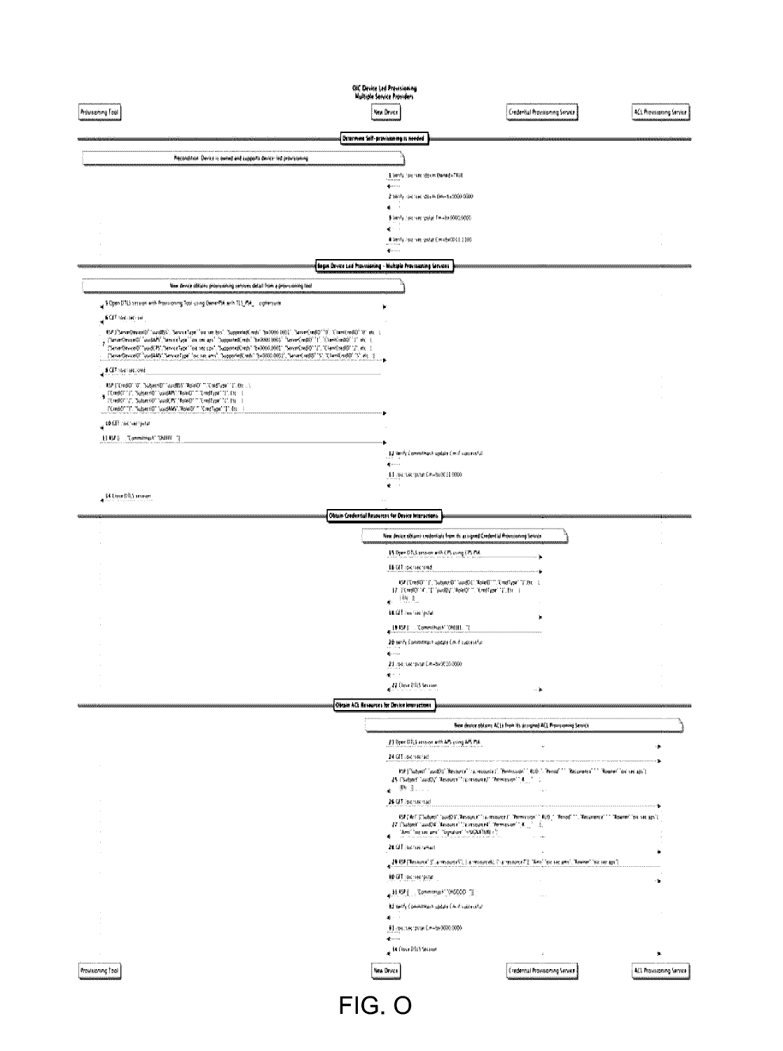

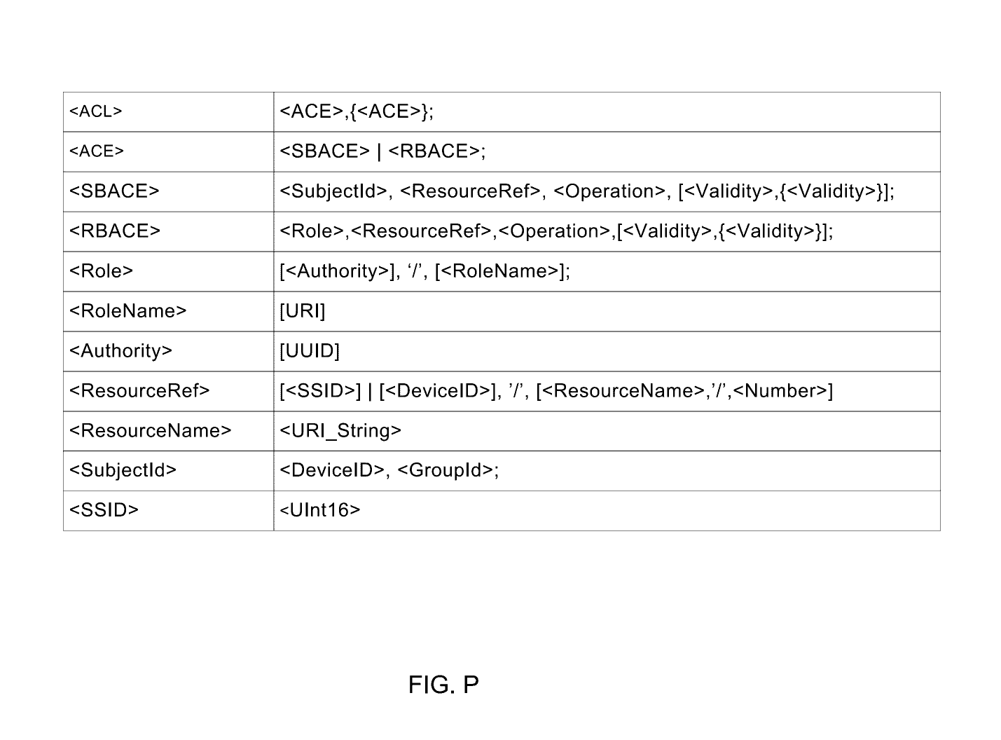

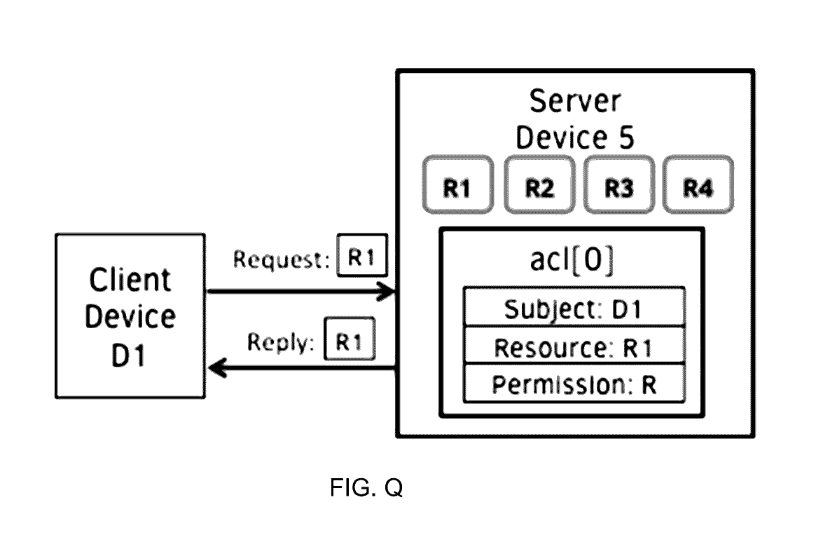

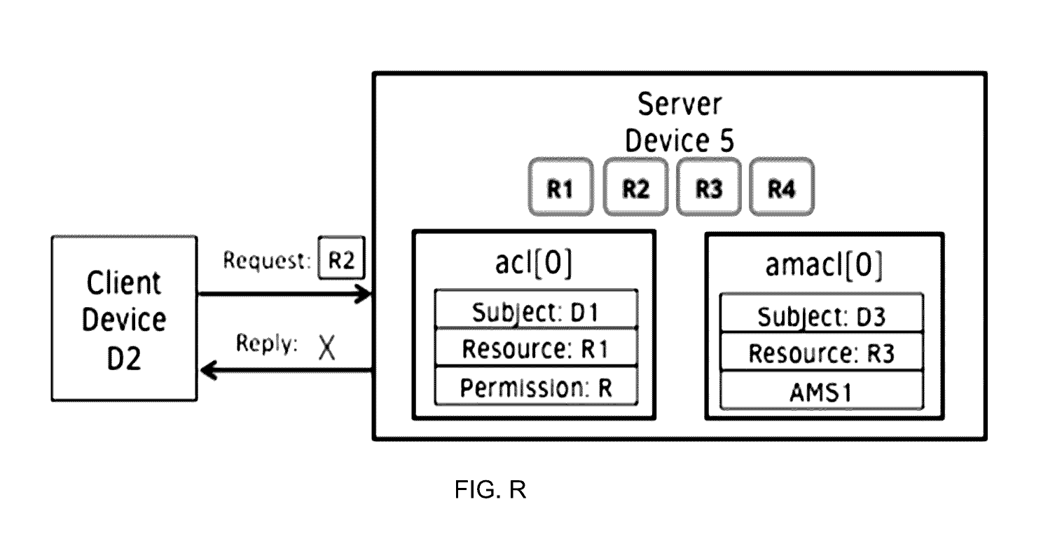

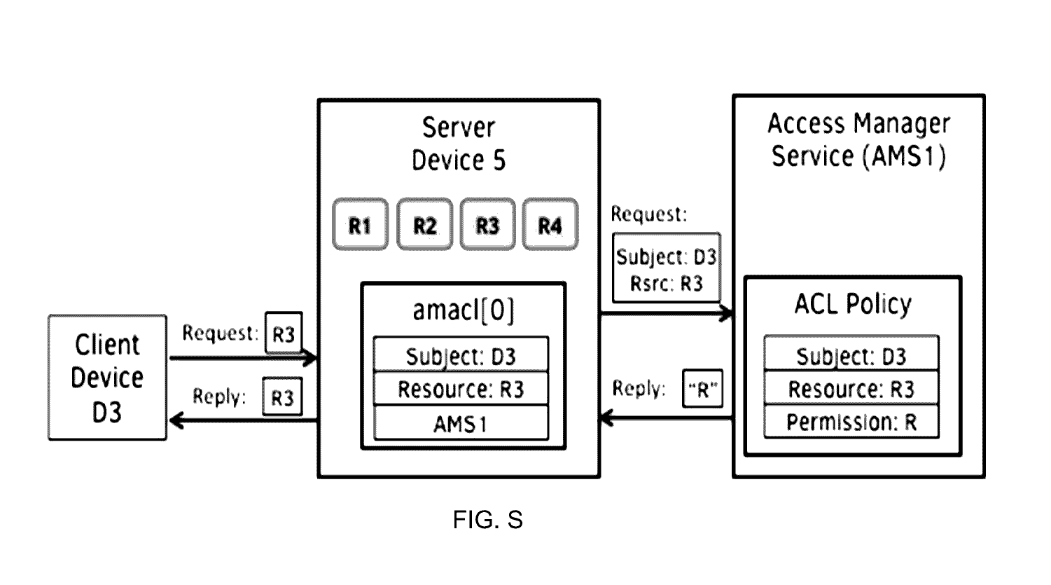

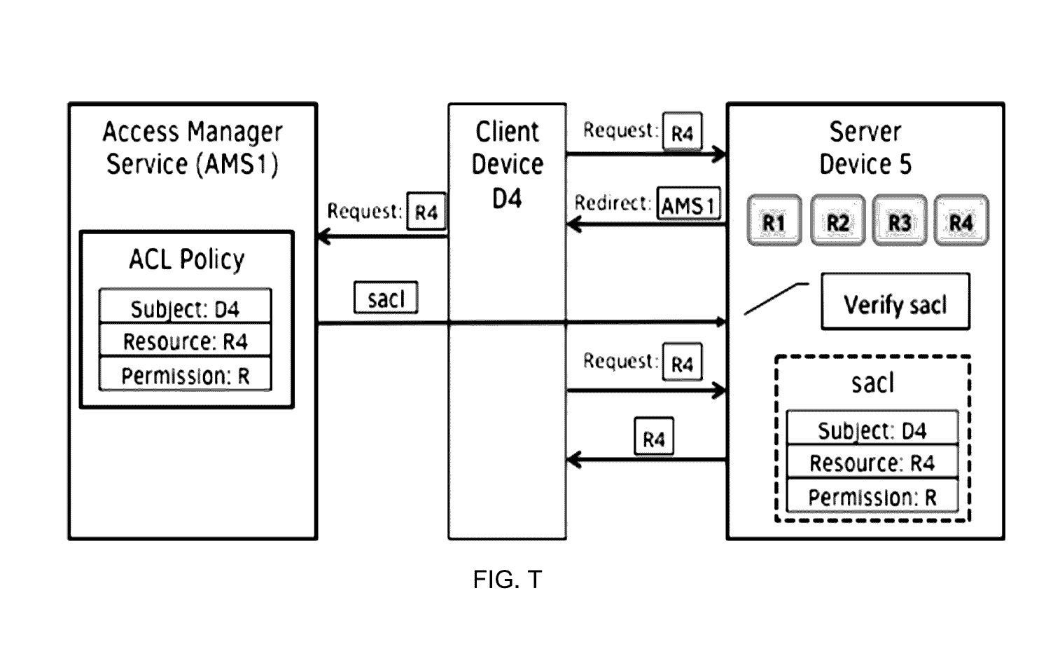

Embodiments may be used in environments where IoT devices may include wearable devices or other small form factor IoT devices. Referring now to FIG. 6, shown is a block diagram of a wearable module 1300 in accordance with another embodiment. In one particular implementation, module 1300 may be an Intel® Curie™ module that includes multiple components adapted within a single small module that can be implemented as all or part of a wearable device. Module 1300 may be configured to be a downstream content consumption device by way of dynamic interaction with an IKM, as described herein. As seen, module 1300 includes a core 1310 (of course in other embodiments more than one core may be present). Such core may be a relatively low complexity in-order core, such as based on an Intel Architecture® Quark™ design. In some embodiments, core 1310 may implement a TEE as described herein. Core 1310 couples to various components including a sensor hub 1320, which may be configured to interact with a plurality of sensors 1380, such as one or more biometric, motion environmental or other sensors. A power delivery circuit 1330 is present, along with a non-volatile storage 1340. In an embodiment, this circuit may include a rechargeable battery and a recharging circuit, which may in one embodiment receive charging power wirelessly. One or more input/output (TO) interfaces 1350, such as one or more interfaces compatible with one or more of USB/SPI/I²C/GPIO protocols, may be present. In addition, a wireless transceiver 1390, which may be a Bluetooth™ low energy or other short-range wireless transceiver is present to enable wireless communications as described herein. Understand that in different implementations a wearable module can take many other forms. Wearable and/or IoT devices have, in comparison with a typical general purpose CPU or a GPU, a small form factor, low power requirements, limited instruction sets, relatively slow computation throughput, or any of the above.

The following Examples pertain to further embodiments.

In Example 1, a system comprises: a content provider interface logic to receive a content license from a content provider, the content license to indicate that the system may distribute digital content associated with the content license to one or more devices; an attestation logic to attest a state of a first device; and a key management logic to generate a content key for the first device responsive to a request by the first device for the digital content and attestation of the first device state, and provide the content key to the first device.

In Example 2, the system of Example 1 further comprises a content rendering logic to receive the digital content from the content provider and render the digital content for the first device.

In Example 3, the content rendering logic is to communicate the rendered digital content to the key management logic to enable the key management logic to send the rendered digital content to the first device to enable the first device to consume the digital content.

In Example 4, the content rendering logic is to render the digital content for the first device responsive to a determination that the first device does not have rendering capability, the first device comprising an IoT device.

In Example 5, the content rendering logic is to render the digital content for the first device based at least in part on device attribute information of the first device.

In Example 6, the system of Example 3 further comprises a key manager server comprising the content provider interface logic, the attestation logic and the key management logic.

In Example 7, the key manager server further comprises an encryption logic to encrypt the rendered digital content received from the content rendering logic and send the encrypted rendered digital content to the first device, where the first device is to decrypt the encrypted rendered digital content with the content key.

In Example 8, the content license of one or more of the above Examples is to indicate that the system is to be a domain controller on behalf of the digital content.

In Example 9, the state of the first device comprises a security state, including existence of a trusted execution environment of the first device.

In Example 10, the first device comprises a maker IoT device not having an embedded manufacturer license.

In Example 11, the system of one or more of the above Examples includes one or more servers. At least one of the one or more servers comprises at least one hardware processor, at least one hardware security processor and at least one secure storage, where the at least one hardware security processor comprises the attestation logic and the key management logic. The at least one hardware security processor may be configured to execute in a trusted execution environment inaccessible to the at least one hardware processor.

In Example 12, a method comprises: receiving a content license from a content provider, the content license to enable the system to be a domain controller for one or more devices and indicate that the system may distribute digital content associated with the content license; attesting a state of a first device; and generating a content key for the first device responsive to a request by the first device for the digital content and attestation of the first device state, and providing the content key to the first device, to enable the first device to decrypt the digital content.

In Example 13, the method further comprises sending the digital content, received from the content provider, to a content rendering system to enable the content rendering system to render the digital content for the first device.

In Example 14, the method further comprises receiving the rendered digital content from the content rendering system and sending the rendered digital content to the first device to enable the first device to consume the digital content.

In Example 15, the method further comprises encrypting the rendered digital content received from the content rendering system and sending the encrypted rendered digital content to the first device, the content key to enable the first device to decrypt the encrypted rendered digital content.

In Example 16, the method further comprises determining whether the first device has rendering capability based at least in part on device attribute information received from the first device and sending the digital content to the content rendering system responsive to a determination that the first device does not have the rendering capability.

In another Example, a computer readable medium including instructions is to perform the method of any of the above Examples.

In another Example, a computer readable medium including data is to be used by at least one machine to fabricate at least one integrated circuit to perform the method of any one of the above Examples.

In Example 17, a system comprises: a key management server having a hardware processor and a security engine, the security engine to receive a content license from a content provider, the content license to indicate that the key management server may distribute digital content associated with the content license to a plurality of devices for which the key management server is a domain controller, attest a state of a first device, generate a content key for the first device responsive to a request by the first device for the digital content and attestation of the first device state, and provide the content key to the first device; and the plurality of devices coupled to the key management server, where at least some of the plurality of devices do not include an embedded manufacturer license to handle digital content.

In Example 18, the system further comprises a content rendering server coupled to the key management server to receive the digital content and render the digital content for the first device, where the content rendering server is to communicate the rendered digital content to the key management server to enable the key management server to send the rendered digital content to the first device to enable the first device to consume the digital content.

In Example 19, the key management server is to encrypt the rendered digital content received from the content rendering server and send the encrypted rendered digital content to the first device, where the first device is to decrypt the encrypted rendered digital content with the content key.

In Example 20, the key management server is to send a shared key to a first subset of the plurality of devices to enable the first subset of the plurality of devices to decrypt first digital content.

In Example 21, the key management server is to concurrently send the first digital content to the first subset of the plurality of devices via a multi-cast communication channel.

In Example 22, a system comprises: means for receiving a content license from a content provider, the content license to indicate that the system may distribute digital content associated with the content license to one or more devices; means for attesting a state of a first device; and means for generating a content key for the first device responsive to a request by the first device for the digital content and attestation of the first device state, and providing the content key to the first device.

In Example 23, the system of Example 22 further comprises means for rendering the digital content for the first device.

In Example 24, the means for rendering is to communicate the rendered digital content to the means for generating to enable the means for generating to send the rendered digital content to the first device to enable the first device to consume the digital content.

Understand that various combinations of the above Examples are possible.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

The following Appendix of information includes additional subject matter that forms part of the disclosure and may be usable in various embodiments.

Terms, Definitions, Symbols and Abbreviations

Terms, definitions, symbols and abbreviations used in this specification are defined by the OIC Core specification. Terms specific to normative security mechanism are defined in this document in context. This section restates terminology that is defined elsewhere, in this document or in other OIC specifications as a convenience for the reader. It is considered non-normative.

TABLE 1
Terminology

| Term | Description |
|---|---|
| Access | The Access Manager Service dynamically |
| Manager | constructs ACL resources in response to a |
| Service | device resource request. An Access Manager |
| | Service can evaluate access policies remotely |
| | and supply the result to an OIC Server which |
| | allows or denies a pending access request. |
| ACL | A name and resource type (oic.sec.aps) given |
| Provisioning | to an OIC device that is authorized to |
| Service | provision ACL resources. |
| Action | A sequence of commands intended for OIC |
| | servers |
| Bootstrap | An OIC device that implements a service of |
| Service | type oic.sec.bss |
| OIC Client | OIC stack instance and application. Typically, |
| | the OIC Client performs actions involving |
| | resources hosted by OIC Servers. |
| Credential | A name and resource type (oic.sec.cps) given to |
| Provisioning | an OIC device that is authorized to provision |
| Service | credential resources. |
| Device | An instance of an OIC stack. Multiple stack |
| | instances may exist on the same platform. |
| Device | RFC 7228 defines classes of constrained devices |
| Class | that distinguishes when the OIC small footprint |
| | stack is used vs. a large footprint stack. |
| | Class 2 and below is for small footprint stacks. |
| Entity | An element of the physical world that is exposed |
| | through an OIC Device |
| DeviceID | OIC stack instance identifier. |
| Device | A utility for introducing a device to a network. |
| On-boarding | |
| Tool | |
| Interface | Interfaces define expected parameters to GET, |
| | PUT, POST, DELETE commands for specific resources |
| Intermediary | A device that implements both client and server |
| | roles and may perform protocol translation, |
| | virtual device to physical device mapping or |
| | resource translation. |
| PlatformID | Uniquely identifies the platform consisting |
| | of hardware, firmware and operating system. |
| | A platform may host multiple OIC Devices. |
| Property | A named data element within a resource. May |
| | refer to intrinsic properties that are common |
| | across all OIC resources. |
| Resource | A data structure that defines the properties, |
| | type and interfaces of an OIC Device. |
| Role | Stereotyped behavior of an OIC device; one of |
| (network | [Client, Server or Intermediary] |
| context) | |
| Role | A property of an OIC credential resource that |
| (Security | names a role that a device may assert when |
| context) | attempting access to device resources. Access |
| | policies may differ for OIC Client if access |
| | is attempted through a role vs. the device |
| | UUID. This document assumes the security |
| | context unless otherwise stated. |
| OIC Server | An OIC resource host. |
| Secure | A module in the OIC Core that implements |
| Resource | security functionality that includes |
| Manager | management of security resources such as ACLs, |
| | credentials and device owner transfer state. |
| System | An application used by a network owner to |
| Management | manage an OIC network of devices including |
| Tool | on boarding and device lifecycle. |
| Sacl | A signed ACL resource that is dynamically |
| | supplied to an OIC Server |

TABLE 2
Symbols and Abbreviations

| Symbol | Description |
|---|---|
| ACL | Access control list |
| AMS | Access manager service |
| APS | ACL provisioning service |
| BSS | Bootstrap service |
| CPS | Credential provisioning service |
| CRUDN | Create, Read, Update, Delete, Notify |
| DOT | Device On-boarding Tool |
| SMT | System Management Tool |
| SRM | Secure Resource Manager |

FIG. A provides OIC interactions. OIC devices may implement OIC Client role that performs Actions on OIC Servers. Actions access Resources managed by OIC Servers. The OIC stack enforces access policies on resources. End-to-end device interaction can be protected using session protection protocol (e.g. DTLS) or with data encryption methods.

The Security specification may use RAML as a specification language and JSON Schemas as payload definitions for all CRUDN actions. The mapping of the CRUDN actions is specified in the OIC Core Specification.

4.4 Document Sections

This document addresses three security topics; security provisioning (Section 7), secure communications (Section 8) and access control (Section 9). Section 5 describes OIC resources that have security significance and defines security resource architecture. Section 6 describes security considerations related resource discovery and proper use of OIC capabilities.

FIG. B provides OIC framework layers (large device). The OIC security objective aims to define and enforce end-to-end security semantics. This is largely achieved by applying security at the OIC Resource Layer. Security resources define access control policy and house security credentials used to establish end-to-end protections. The security layer within the OIC Resource layer defines the security endpoint for purposes of end-to-end security. Protection of security resources (credentials, ACLs, secure sessions and security configurations etc. . . . ) may be considered by product engineers to best determine how endpoint hardening is achieved.

5.1 Endpoint Protection Philosophy (Informative)

Endpoint protection philosophy can be considered at four scoping levels; (1) group, (2) device, (3) resource and (4) property scope.

Group Level Access—Group scope means access control, authentication and data protection are applied to the group of devices. Group credentials may be used when encrypting data to the group. Group members may authenticate as a member of a group to external entities using shared or privacy preserving credentials. Member devices may be trusted to a minimum standard defined by the group. End-to-end data protection semantics ensures group members have shared access to group data but non-group members are granted explicit access.

Device Level Access—Device scope means access control, authentication and data protection are applied to device endpoints. The device endpoint may contain multiple OIC Resources. Device level access implies accessibility extends to all resources available to the device. End-to-end protection means the device instance identified by its OIC DeviceID is the endpoint. The semantics of pairwise credentials asserts that if a device-A knows a paired device-B shares a pairwise key, only devices A and B share that key. Use of a pairwise key can be used by device-A to authenticate device-B by asserting that if the authentication challenge was not created by device-A, then only device-B could have supplied the challenge. Pairwise keys can be used to establish secure communication between devices A and B that protect data integrity and confidentiality. Pairwise keys may protect DTLS sessions or to encrypt messages and resources using a data marshaling technique such as JSON Web Encryption (JWE) and JSON Web Signatures (JWS).

Resource Level Access—Resource level scope means access is controlled on a per OIC Resource basis. Resource access requires an Access Control List (ACL) that specifies the device resource(s) that may be accessed by a remote subject. The ACL contains the permission set that will be applied for a given resource requestor. Permissions consist of a combination of Create, Read, Update, Delete and Notify (CRUDN) actions. Requestors authenticate as either a device or a device operating with a particular role. OIC devices may acquire elevated access permissions when asserting a role. For example, an ADMINISTRATOR role might expose additional resources and interfaces not normally accessible.

Property Level Access—Property level scope means access is controlled on a per property basis. Resources normally consist of one or more properties. Since different properties achieve different objectives each may require different permissions. Property level access control is achieved by creating a Collection resource that references other resources containing a single property. This technique allows the resource level access control mechanisms to be used to enforce property level granularity.

5.2 Security Provisioning (Informative)

Provisioning of security resources is accomplished with minimal dependence on external layers for security. The provisioning approach is designed to follow a device lifecycle that begins with an on-boarding process that includes device ownership establishment followed by configuration of a bootstrap service. The bootstrap service provisions OIC security resources. Security resources may include additional services for doing key management, access management, device update or other security services yet to be defined.

Devices are aware of their security provisioning status. Self-awareness allows them to be proactive about provisioning or re-provisioning security resources as needed to achieve the devices operational goals. (See Figure J, Figure K).

5.3 Security Theory of Operation (Informative)

Security is applied within the OIC stack instance at the ‘device’ level where end-to-end protection mechanisms apply authentication, confidentiality and integrity. Access to device resources may be controlled with finer granularity within the context of the end-to-end protection mechanism such as DTLS. The security theory of operation is described in the following three steps.

FIG. C provides steps an OIC client takes to access an OIC server's resources.

Step-1—The OIC Client establishes a network connection to the OIC Server. The connectivity abstraction layer ensures the devices are able to connect despite differences in connectivity options. The OIC DeviceID disambiguates the device endpoint. Network addresses map to DeviceIDs. Network address is used to establish connectivity, but security policy is expressed in terms of DeviceID. There may be a binding between the device context and the platform implementing the device. The platform may provide device isolation and execution environment hardening that prevents a rogue device from masquerading as a legitimate device. Platform hardening and device isolation mechanisms may be assessed at device on-boarding and through attestation protocols subsequent to device on-boarding.

Step-2—The second step establishes a secure end-to-end channel that protects the exchange of OIC messages and resources passed between devices. End-to-end encryption keys are stored in the local platform using the best available key storage technique. Keys are obtained from the key store using a key handle kept in the OIC credential resource. Each OIC device uses encryption keys to securely exchange resource information. The set of devices the OIC Server is able to communicate with securely is contained in the OIC services resource.

Every OIC application uses resources that are referenced by an OIC Server ACL resource. The ACL describes resource level access rights. The ACL is itself an OIC resource. ACLs can specify access permissions for other ACL resources. ACL resources also specify an owner service that does not require an ACL verification check. This avoids ACL provisioning circularity. ACLs can match multiple resources for a given subject (aka device or role). There is a wild card syntax that matches multiple resources at once.

An OIC Client is authenticated as part of step 2 secure session establishment. The ACL entry is matched when the credential used identifies the subject in an ACL resource. There is a wild card ACL subject that allows anonymous requestors. Anonymous subjects supports semantics where the resource being accessed is available to all devices and services. Requestors may assert a role when performing an action requiring privileged access.

Step 3—The final step applies the ACL permission to the requested resource where the decision to allow or deny access is enforced by the OIC Server's Secure Resource manager (SRM).

FIG. D provides secure resource manager (SRM) as the OIC device enforcement point. The Secure Resource Manager (SRM) is the security enforcement point within an OIC Server.

The OIC access control theory of operation requires the requesting device satisfy the security requirements before accessing application resource(s). This is achieved by establishing a connection using well-known port addresses, one for unsecure traffic and another for secured traffic. An OIC Client knows when to select the secure or unsecure port by inspecting resource introspection results. Introspection indicates whether the resource requires device authentication as a prerequisite to access.

Device authentication requirements drive credential-provisioning tasks that occur when a device is on-boarded into the network. A device management utility determines which devices interact with which other devices then determines which security resources are needed. Provisioning security resources is an important prerequisite to normal operation. Subsequent to device provisioning the services resource in the OIC Server will contain credentials appropriate for establishing a secure connection with the OIC Client. Credential resource can support a variety of credentials that authenticates the client and establishes session keys for encryption and integrity protection.

User authentication is not explicitly required by OIC security. Users are authenticated by the OIC aware application. OIC applications associate OIC devices with users. If a specific user is authorized to perform specific operations embodied in an OIC Client, the application developer will configure OIC Clients according to the needs of each user.

OIC ACL policies are expressed at the resource level of granularity. Resources consist of one or more properties that may under certain circumstances require different access than a second property belonging to the same resource. In this circumstance, the resource designer may divide the resource into a collection resource that references the child resources.

FIG. E provides example resource definition with opaque properties. An example resource schema shows the definition of and “oic.thing” resource with two properties: Property-1 and Property-2. Since OIC framework treats property level detail as opaque, it is not possible to author an ACL policy that assigns read-only access to Property-1 and write-only access to Property-2.

FIG. F provides example resource definition with property-level access control using resource ACLs with read access for the first property and write access for the second. Property level access control can be applied when the resource definition is restricted as an OIC Collection where a new resource “oic.RsrcProp-1” is defined having a single property, “Property-1”. A second new resource “oic.RsrcProp-2” contains a single property “Property-2”. Although Property-1 and Property-2 remain opaque to the OIC framework, property level access can be applied using the resource-level ACLs.

The collection resource itself may have an ACL. However, the permissions granted to the collection resource mayn′t be applied to any of the resources named in the collection. Every resource that requires an ACL constraint is explicitly named by the ACL resource.

Note that batch interface semantics when applied to a collection resource may allow privilege escalation. The requestor authenticates to the collection's ACL, but the batch action is applied to the devices referenced by the collection. The referenced devices have their own credentials that may differ from that of the original requestor. The referenced devices' credentials may have been granted greater (or lesser) privilege than the original requestor resulting in privilege escalation (or insufficient privilege to complete the operation). Privilege escalation is desirable when it is inappropriate for the original requestor to access the collection resources directly or to assign a special role to the original requestor.

FIG. G provides OIC security resources. The following resources have security relevance:
/oic/sec/acl—local access control list
/oic/sec/amacl—dynamically obtains an access control list using an access manager service
/oic/sec/sacl—signed ACL issued by an access manager service
/oic/sec/cred—credential resource
/oic/sec/svc—services requiring secure connections
/oic/sec/pstat—provisioning status of security resources
/oic/sec/doxm—device owner transfer methods resource

ACL apply to all resources except the /oic/sec/acl resource that refers to it's self. ACL resources have a network management tool that is authorized to update the ACL resource. Nevertheless, it is allowable for an ACL resource to control access to another ACL resource; or any other security resource.

The /oic/sec/svc resources and /oic/sec/cred resources can be created and updated by a resource owner. Hence, there isn't a dependency on an ACL provisioning step as a pre-requisite to provisioning these resources.

Security resources have intrinsic limitations that cannot be overridden by ACL policies. For example the /oic/sec/cred resource contains PrivateData property that is not readable or writable. The Owner is the only entity other than the device itself that can access this property.

6 Security Capabilities and Discovery (Informative)

Discovery of security relevant resources follows OIC core resource discovery conventions. Security resource may contain sensitive content for a given deployment. This specification does not attempt to determine whether fields have privacy implications within the owned network context. End-to-end protection (e.g. DTLS) may be used to ensure sensitive content is not disclosed to non-owned entities.

Credential resources containing sensitive values are not exposed in the clear in response to discovery and introspection requests. Encrypted sensitive values in credential resources may be exposed outside of an OIC stack instance. Cryptographic keys, passwords, PINs are examples of sensitive values. All other fields may be privacy sensitive values. However, ACL resources are not intended as a privacy protection mechanism.

TABLE 3
Intrinsic Limitations To Resource Property Access

| | Implicit Access | Explicit Access |
|---|---|---|
| | (These entities may override | (These entities can be |
| Permis- | explicit access rights for the | given explicit access |
| sion | specified permission) | rights) |
| — | OIC framework may override | Owner -a resource owner, |
| | access for the local resource. | assigned to the resource |
| | Device management tool may | during resource provi- |
| | override access during a device | sioning can override |
| | owner transfer/initial provisioning. | this permission. |
| C | OIC framework | Owner |
| | Device management tool. | ACL - Access is further |
| | PUT, POST methods | constrained by an ACL |
| | | entry. |
| R | OIC framework | Owner |
| | Device management tool | ACL |
| | GET, OBSERVE methods | |
| U | OIC framework | Owner |
| | Device management tool | ACL |
| | PUT, POST methods | |
| D | OIC framework | Owner |
| | Device management tool. | ACL |
| | DELETE method | |
| N | OIC framework | Owner |
| | Device management tool. | ACL |
| | NOTIFY methods | |

7 Security Provisioning

7.1 Overview (Informative)

During the provisioning phase the target device is being configured with credentials to be used for authorized subjects and access level permissions (Access Control Lists) that defines who is allowed to do what for a given resource.

This section defines the provisioning requirements for the OIC stack including the high level flow required to complete the bootstrapping.

The term on-boarding refers to a process through which a device is introduced into the owner's environment. As part of overall on-boarding, there may be the need to securely transfer device ownership from a previous owner or manufacturer to the intended owner. Owner transfer can be a point of attack since it may be difficult to detect this attack subsequently. Techniques for secure ownership transfer are important for understanding and managing security risks throughout the lifetime of the IoT network. There may be many owner transfer techniques with a wide range of security properties. Device manufacturers may make challenging trade-off decisions that balance security needs with other product requirements. The OIC specification allows for manufacturer specific mechanisms for transferring device ownership called ‘out-of-band transfer of ownership’. The OIC specification defines an interoperable ‘just-works transfer of ownership’ method.

OIC defines the format of a pre-shared key established when the new device is introduced into an owner's network called the “OwnerPSK”. The OwnerPSK is the result of an out-of-band transfer of ownership method between the previous owner/manufacturer and the new owner. Both the OOB and Just-Works methods produce a pre-shared key value that is used to assert device ownership. The OwnerPSK is used to generate the symmetric keys that are used for other purposes. For example, a pair-wise PSK is used to protect device-provisioning data from a system management tool.

Figure H shows a hypothetical system management tool that includes an on-boarding tool. It also shows several other tools that might be useful for provisioning an IoT system. The tool may consist of several disparate or combined tools; a Device On-boarding Tool (DOT), System Authoring Tool (SAT) and a Bootstrap and Provisioning Tool (BPT). The DOT establishes which physical devices are owned by the system and are available to the system object model. The SAT provides a user interface for designing various interaction semantics between devices. The BPT establishes a connection with each device needing provisioning by discovering devices in need of provisioning. Alternatively, devices can track their provisioning status and seek provisioning of a BPT service. When a connection is established, the OwnerPSK may be used to establish a secure connection. The BPT may provision security relevant resources at that time, including ACLs, credentials and other configuration data.

Security resource provisioning follows device “on-boarding”. Device provisioning objectives enable new devices to interact with existing devices securely. This involves establishing security credentials that are used to authenticate each device with every other device with which it needs to interact. Credentials contain the keys used to establish a secure communication channel and to evaluate access rights.

A hierarchy of keys is envisaged that follows a network provisioning strategy that ascribes broadly impactful, but seldom used keys to the root of the hierarchy. Keys with narrower impact that may be used more frequently are ascribed to the leaves of the hierarchy, as shown in Table 4.

TABLE 4

| Key | Instances | Function |
|---|---|---|
| Owner PSK | 1 per device per owner | Take Ownership |
| Bootstrap | 1 per device per device | Configure network services |
| Server key | deployment | |
| Security | 1-3 per device | Provision credentials, ACLs and |
| Provisioning | | other security objects |
| Services keys | | |
| Pair-wise keys | 1 per device-device | Autonomous device-device |
| | pairing | interactions |
| Temporal keys | 1 per session | Semi-autonomous and ad-hoc |
| | | device-device interactions |

OIC devices maintain provisioning status so that provisioning tasks may be performed by multiple services and may resume following system reset or other interruption. Devices may take a proactive role in finding the provisioning service that satisfies the type of provisioning needed. For example, if an OIC Client request fails due to lack of a suitable ACL entry. The OIC Server may request ACL provisioning of its ACL provisioning service. Provisioning is discussed in more detail in Section 7.3. ACL handling is discussed in Section 9.

A secure connection (e.g. DTLS) is used whenever provisioning is attempted to minimize risk of successful attack on the services that define and instantiate the system. Security credentials are used to authenticate OIC devices whether acting in the capacity of client, server or intermediary and to integrity and confidentiality protect device interactions.

Credential provisioning is an important first step following device on-boarding. Among the first credentials provisioned are for services used to further the provisioning activity. Provisioning services use credentials having pre-shared keys that are in turn used to secure the communication channel over which additional provisioning activities may continue.

Cryptographic keys have a lifetime. It may be necessary to refresh cryptographic keys before their lifetime is reached. OIC architecture supports two forms of key refresh mechanism:
1) Key re-provisioning using a credential provisioning service
2) Use of the pair-wise pre-shared key (PSK) with Diffie-Helllman key agreement to produce a new PSK.

If a device is compromised, lost or stolen, credential re-provisioning is needed to remove the credentials that refer to the device. If the device is recovered and found to be trusted for re-use, the device may be reset to manufacturer defaults and device ownership may be re-asserted.

7.2 Device Ownership (Informative)

Device on-boarding may include a method whereby the device owner establishes device ownership. A network management tool may be used to performing device ownership transfer operations. This procedure may be proprietary. This specification anticipates both proprietary and OIC standard device owner transfer methods will be used.

7.2.1 Existing Device Ownership Transfer Approaches (Informative)

There are multiple ways in which manufacturers transfer device ownership to the customer. The table below identifies several approaches. If a vendor-specific method is used, a pre-shared key is the result so that it may be used with OIC security resources and protocols.

Device ownership methods have different security, usability and convenience trade-offs. The right method may be unique to the product and the owner's security expectations. In each case however, the end result is the device contains an owner credential.

TABLE 5
Common methods for transferring device ownership

| Approach | Description | Security Considerations |
|---|---|---|
| Just-Works | Mfg encodes a well-known pairing value | The attacker can be the first person to |
| | such as all zeros. | respond to a owner transfer event then |
| | | spoof the legitimate new owner. |
| Mode Switch | Mfg supplies a switch or button that the | If the attacker comes into physical |
| | user activates to enable functions for | proximity of the device, it is at risk of |
| | taking ownership | being spoofed. |
| Random Device | Device generates a random value that | The attacker can be the first person to |
| PIN | is displayed to a user. User enters the | respond to the owner transfer event |
| | value via a remote device. The first | within the window of time in which the |
| | device to successfully supply the PIN is | PIN is valid. The attacker can then spoof |
| | the new owner. | the legitimate new owner. |
| Pre-provisioned | The manufacturer injects a PIN into the | The attacker obtains the PIN take |
| Device PIN | device ROM at manufacturing time. The | ownership then install attack SW/FW on |
| | PIN is given to the new owner over an | the device. Attacker may allow real owner |
| | out of band channel, (e.g. printed with | to take ownership then reset the device |
| | device packaging). | to re-take ownership. |
| Pre-provisioned | The manufacturer injects a strong | Attacker injects attack keys during |
| strong credential | cryptographic key into the device and | manufacture process and spoof new |
| | distributes the key to the new owner. | owner when device is delivered. |

7.2.2 Vendor-Specific Owner Establishment (Informative)

The OwnerPSK is a pre-shared key that is the product of an ownership transfer method. Table 5, shows classes of these methods. A pre-shared key called the “OwnerPSK” is the result of a device owner transfer method (DOXM). The following paragraph outlines an approach for constructing OwnerPSK given possible available input values.

The OwnerPSK generation method is informative only. Guidelines are provided for convenience purposes only:

OwnerPSK=PRF(Random,DeviceLabel,NewOwnerLabel,PreviousOwnerLabel);

Where: PRF is a pseudo-random function used for key generation that cryptographically combines function parameters such that it exhibits pre-image resistance, collision resistance and second pre-image resistance.

Random is a random value with sufficient entropy,

DeviceLabel identifies the device, whose ownership is being transferred,

NewOwnerLabel is a value supplied by the new owner acknowledging the intent to become the new owner. If the platform contains a platform ownership capability such that multiple OIC device instances hosted on the same platform would not require taking ownership subsequent to the first OIC device instance. The NewOwnerLabel may identify the platform ownership method and may reference the platform owner authorization data. The NewOwnerLabel values may be shared between OIC Device and owner transfer service to facilitate OwnerPSK computation using the prf( ).

PreviousOwnerLabel is a value supplied by the previous owner acknowledging the intent to transfer ownership to the new owner.

7.2.3 OwnerPSK Format (Normative)

The OwnerPSK value may have the following format:

128-bit key:

| Name | Value | Type | Description |
|---|---|---|---|
| Length | 16 | OCTET | Specifies the number of 8-bit octets |
| | | | following Length |
| Key | opaque | OCTET | 16 byte array of octets. When used as |
| | | Array | input to a PSK function Length is omitted. |

256-bit key:

| Name | Value | Type | Description |
|---|---|---|---|
| Length | 32 | OCTET | Specifies the number of 8-bit octets |
| | | | following Length |
| Key | opaque | OCTET | 32 byte array of octets. When used as |
| | | Array | input to a PSK function Length is omitted. |

7.2.4 OIC Just-Works Device Owner Transfer Method (Normative)

Compliant OIC devices may implement the just-works owner transfer method as shown in FIG. 1 to ensure interoperability. This method relies on an anonymous Diffie-Hellman key agreement protocol to arrive at symmetric keys that are input to the OwnerPSK calculation.

Supported Ciphersuites:
TLS_ECDH_ANON_WITH_AES_128_CBC_SHA,
TLS_ECDH_ANON_WITH_AES_256_CBC_SHA,
TLS_ECDH_ANON_WITH_AES_128_CBC_SHA256,
TLS_ECDH_ANON_WITH_AES_256_CBC_SHA256,

Note: Device classes are defined in RFC 7228 and RFC 6655.

All OIC Devices May Implement:
TLS_ECDH_ANON_WITH_AES_128_CBC_SHA.

Class-2 and Lower Devices MAY Implement:
TLS_ECDH_ANON_WITH_AES_128_CBC_SHA256,
TLS_ECDH_ANON_WITH_AES_256_CBC_SHA,
TLS_ECDH_ANON_WITH_AES_256_CBC_SHA256

Devices Above Class-2 May Implement:
TLS_ECDH_ANON_WITH_AES_128_CBC_SHA256,
TLS_ECDH_ANON_WITH_AES_256_CBC_SHA, TLS_ECDH_ANON_WITH_AES_256_CBC_SHA256

The OwnerPSK calculation may follow the following format to ensure interoperability across different vendor products:

OwnerPSK=PRF(MasterSecret,Message,Length);

Where:
PRF may use TLS PRF defined by RFC5246.
MasterSecret is the master secret key resulting from the DTLS handshake
Message is a concatenation of the following:
DoxmType string for the just works method (e.g. “oic.sec.doxm.jw”)
OwnerID is a URI identifying the device owner identifier and the device that maintains OwnerPSK.
DeviceID is new device's DeviceID (e.g. “urn:uuid:XXXX-XXXX-XXXX-XXXX”).
Length is the length of Message in octets

7.2.5 OIC Out-of-Band PIN Device Owner Transfer Method (Normative)

The PIN-based device owner transfer method as shown in FIG. J uses a pseudo-random function (PBKDF2) defined by RFC2898 and a PIN exchanged via an out-of-band method (which is outside the scope this specification) to generate a pre-shared key. The PIN-authenticated pre-shared key (PPSK) is supplied to a TLS ciphersuite that accepts a PSK.

PPSK=PBKDF2(PRF,PIN,DeviceID,c,dkLen)

The PBKDF2 function has the following parameters:
PRF—Uses the DTLS PRF.
PIN—obtain via out-of-band channel.
DeviceID—UUID of the new device.
c—Iteration count initialized to 1000, incremented upon each use.
dkLen—Desired length of the derived PSK in octets.

The PPSK is supplied to one of the following TLS ciphersuites:
TLS_ECDHE_PSK_WITH_AES_128_CBC_SHA, (* 16 octet integrity check *)
TLS_ECDHE_PSK_WITH_AES_256_CBC_SHA,
TLS_ECDHE_PSK_WITH_AES_128_CBC_SHA256,
TLS_ECDHE_PSK_WITH_AES_256_CBC_SHA256,
TLS_PSK_DHE_WITH_AES_128_CCM_8, (* 8 octet integrity check *)
TLS_PSK_DHE_WITH_AES_256_CCM_8,
TLS_DHE_PSK_WITH_AES_128_CCM,
TLS_DHE_PSK_WITH_AES_256_CCM

See RFC4279, RFC5489 and RFC6655.

All OIC Devices May Implement:
TLS_ECDHE_PSK_WITH_AES_128_CBC_SHA,
TLS_PSK_DHE_WITH_AES_128_CCM_8,

Class-2 and Lower Devices May Implement:
TLS_ECDHE_PSK_WITH_AES_256_CBC_SHA,
TLS_ECDHE_PSK_WITH_AES_128_CBC_SHA256,
TLS_ECDHE_PSK_WITH_AES_256_CBC_SHA256,
TLS_PSK_DHE_WITH_AES_256_CCM_8,
TLS_DHE_PSK_WITH_AES_128_CCM,
TLS_DHE_PSK_WITH_AES_256_CCM

Devices Above Class-2 May Implement:
TLS_ECDHE_PSK_WITH_AES_256_CBC_SHA,
TLS_ECDHE_PSK_WITH_AES_128_CBC_SHA256,
TLS_ECDHE_PSK_WITH_AES_256_CBC_SHA256,
TLS_PSK_DHE_WITH_AES_256_CCM_8,
TLS_DHE_PSK_WITH_AES_128_CCM,
TLS_DHE_PSK_WITH_AES_256_CCM

The OwnerPSK calculation is the same as defined for the oic.sec.doxm.jw method (see section 7.2.3).

7.2.6 Device Owner Transfer Methods and State (Normative)

The /oic/sec/doxm resource contains the set of supported device owner transfer methods.

Security resource are discoverable through the /oic/res resource. Resource discovery processing respects the CRUDN constraints supplied as part of the security resource definitions contained in this specification.

TABLE 6
Owner Transfer Method resource definition

| | | | | | |
|---|---|---|---|---|---|
| | | Resource | | | Related |
| Fixed | Resource | Type ID | Inter- | | Functional |
| URI | Type Title | (“rt” value) | faces | Description | Interaction |

| | | | | |
|---|---|---|---|---|
| /oic/sec/doxm | Device Owner | urn:oic.sec.doxm | Resource for supporting | Configuration |
| | Transfer Methods | | device owner transfer | |

TABLE 7
Owner Transfer Method Properties definition

| Property | Property | Value | Value | | Access | | | |
|---|---|---|---|---|---|---|---|---|
| Title | Name | Type | Rule | Unit | Mode | Mandatory | Instance | Description |
| Owner | Oxm | OxmType | — | | R | Yes | Multiple | URN identifying |
| Transfer | | | | | | | | the organization |
| Method | | | | | | | | defining the |
| | | | | | | | | owner transfer |
| | | | | | | | | method and the |
| | | | | | | | | method name. |
| Oxm | OxmSel | OxmType | — | | R | Yes | Single | The Oxm that |
| Selection | | | | | | | | was selected for |
| | | | | | | | | device |
| | | | | | | | | ownership |
| | | | | | | | | transfer. |
| Owned | Owned | Boolean | T\|F | | R | Yes | Single | Indicates |
| | | | | | | | | whether or not |
| | | | | | | | | the device |
| | | | | | | | | ownership has |
| | | | | | | | | been |
| | | | | | | | | established. |
| | | | | | | | | FALSE indicates |
| | | | | | | | | device is |
| | | | | | | | | unowned. |
| DeviceID | DidFormat | UINT8 | 0-255 | | R | Yes | Single | Enumerated |
| Format | | | | | | | | device ID |
| | | | | | | | | format. |
| | | | | | | | | [0 = URN] (e.g. |
| | | | | | | | | urn:uuid:XXXX- |
| | | | | | | | | XXXX-XXXX- |
| | | | | | | | | XXXX) |
| DeviceID | DeviceID | OCTET[ ] | — | | R | Yes | Single | DeviceID |
| | | | | | | | | assigned to this |
| | | | | | | | | instance of the |
| | | | | | | | | OIC framework. |
| | | | | | | | | Did Format |
| | | | | | | | | determines how |
| | | | | | | | | to interpret the |
| | | | | | | | | OCTET string |
| Device | DevOwner | oic.sec.svc | — | | R | Yes | Single | URI identifying a |
| Owner | | | | | | | | service that is |
| | | | | | | | | the device |
| | | | | | | | | owner. This may |
| | | | | | | | | be any value |
| | | | | | | | | chosen by the |
| | | | | | | | | device owner. |
| Resource | Rowner | oic.sec.svc | — | | R | Yes | Single | This resource's |
| Owner | | | | | | | | owner. Typically |
| | | | | | | | | this is the |
| | | | | | | | | bootstrap |
| | | | | | | | | service that |
| | | | | | | | | instantiated this |
| | | | | | | | | resource |

The owner transfer method resource contains an ordered list of owner transfer methods where the first entry in the list is the highest priority method and the last entry the lowest priority.

The device manufacturer configures this resource with the most desirable (most secure) methods with high priority and least desirable with low priority. The network management tool queries this list at the time of on boarding when the network management tool selects the most appropriate method.

Subsequent to an owner transfer method being chosen the agreed upon method may be entered into the /doxm resource using the OxmSel property.

Owner transfer methods consist of two parts, a URN identifying the vendor or organization and the specific method.

<OxmType> ::= “urn:” <NID> “:” <NSS>
<NID> :: = <Vendor-Organization>
<NSS> ::= <Method> | {<NameSpaceQualifier> “.”} <Method>
<NameSpaceQualifier> ::= String
<Method> ::= String
<Vendor-Organization> ::= String

When an owner transfer method successfully completes, the Owned property is set to ‘1’ (TRUE). Consequently, subsequent attempts to take ownership of the device will fail.

The Secure Resource Manager (SRM) generates a device identifier (DeviceID) that is stored in the /oic/sec/doxm resource in response to successful ownership transfer.

Owner transfer methods may communicate the DeviceID to the service that is taking ownership. The service may associate the DeviceID with the OwnerPSK in a secured database.

Once owned, the bootstrap service (oic.sec.bss) may change the owned state to ‘0’ (FALSE).

TABLE 8
OIC defined owner transfer methods

| | | Enumer- | |
|---|---|---|---|
| Value Type | Value Type | ation | |
| Name | URN | Value | Description |
| OICJustWorks | urn:oic:oic.sec.doxm.jw | 0 | The just-works method relies on anonymous |
| | | | Diffie-Hellman exchange to realize a shared |
| | | | secret. It is subject to man-in-the-middle |
| | | | threats. |
| OICSharedPin | urn:oic:oic.sec.doxm.pin | 1 | The shared PIN method relies on an out-of- |
| | | | band PIN distribution method to generate a |
| | | | shared secret that mitigates many man-in- |
| | | | the-middle threats. |

7.3 Provisioning (Informative)

OIC security provisioning anticipates network deployments having multiple specialized services.
Bootstrap service implements device owner transfer protocols
Credential provisioning service implements key management protocols
Access control policy provisioning service implements ACL provisioning
Access management service implements authorization services

New service types may be added in the future.

Services deployment may combine all services into a single server or multiple servers may cooperate to specialize.

7.3.1 Provisioning a Bootstrap Service

The bootstrap service credential is provisioned to a device as part of applying the device owner transfer method. This credential may be used subsequently to discover and establish a secure connection to a bootstrap service.

The oic.sec.bss creates or updates the oic.sec.svc resources for credential provisioning service, ACL provisioning service and potentially other services. The oic.sec.svc resource contains a list of services the device may consult for self-provisioning. The oic.sec.bss entry identifies the bootstrap service. The oic.sec.bss service may use a pre-shared key to establish a secure connection with a device. The oic.sec.cred resource is provisioned with the PSK by a mediator or the PSK may be dynamically established using a Diffie-Hellman exchange. See Section 8.3 for details related to Diffie-Hellman PSK generation. If the oic.sec.bss service is provisioned by a network administration tool, the PSK may be derived using the OwnerPSK as the PSK input to a TLS ciphersuite that accepts a PSK parameter.

After the oic.sec.bss PSK is established, it may be used to refresh the bootstrap server PSK following the approach defined in Section 8.3.

7.3.2 Provisioning Other Services

Other servers may specialize in the type of provisioning that is performed. Each device may posses an oic.sec.svc resource that describes which service entity to select for provisioning support. A single server may host multiple provisioning services. This flexibility allows localized as well as centralized functions.

A bootstrap service may be used to provision other services. The bootstrap service may initiate service provisioning by triggering the device to re-provision its credential resources. The device instantiates oic.sec.svc and oic.sec.cred resources for each provisioning service with which the device may need to interact.

A bootstrap service may provision credentials for support services of the following type:
oic.sec.cps
oic.sec.aps
oic.sec.ams

The bootstrap service provisions the appropriate keys to allow provisioning service and OIC device to establish a secure session. Subsequent to bootstrap provisioning, the support service's credential resource will contain a key that a corresponding OIC Device credential resource can verify; and vise versa.

OIC Server devices may restrict the type of key (CredType) supported. OIC Client devices may support all CredTypes (see Table 14) to facilitate interoperability.

7.3.3 Credential Provisioning

OIC clients and servers may be configured for secure interactions for both pairwise and group semantics. Several types of credential are supported by a /oic/sec/cred resource. They include at least the following key types; pairwise symmetric keys, group symmetric keys, asymmetric keys and signed asymmetric keys. Keys may be provisioned by a credential provisioning service (e.g. “oic.sec.cps”) or dynamically using a Diffie-Hellman key agreement protocol.

See Figure L for example credential provisioning flows and Section 8.3 for Diffie-Hellman based key agreement.

7.3.3.1 CPS Mediated Credential Provisioning

Device-device interaction requires each device to seek credential provisioning. A device may discover the need to update credentials if a secure connection attempt fails. The device requests credential update by establishing a secure connection to a credential provisioning service. The device may enter credential-provisioning mode (e.g. /oic/sec/psta.Cm=16) and may configure operational mode (e.g. /oic/sec/pstat.Om=“1”). The device requests an update to its credential resource. The CPS responds with a new pairwise pre-shared key (PSK). The CPS may wait for a request from the second device or may initiate a provisioning operation with the second device to complete the provisioning. A device causes the target device to seek provisioning by sending it a /oic/sec/cred resource that identifies the needed credential. Since the credential PSK is assigned by a CPS, it is omitted from the “PrivateData” property.

The credential provisioning service may initiate credential provisioning with the devices that have the /oic/sec/pstat.Om configured for provisioning by a provisioning server.

The device may remain in credential update mode until the expected credential is successfully updated.

Figure K is a CPS mediated credential provisioning.

7.3.3.2 Symmetric Pairwise-Key Credential Establishment

Some conditions favor device-to-device credential creation. Such circumstances include:
When a CPS is not available due to connectivity limitation
When devices dynamically connect over wireless PAN
When devices from different networks connect in ad-hoc fashion

FIG. 1 is a device-to-device negotiation of pairwise credentials.

7.3.3.3 Role Assignment

OIC Clients can operate with roles such as ‘Administrator’ or ‘Zone_1’ etc. . . . . Roles are defined by the credential provisioning service (e.g. rt=“oic.sec.cps” or by a network administration tool. Roles are properties in a credential resource. OIC servers enforce role constraints using ACLs.

OIC client devices seeking role provisioning may want to enter (exit) the /oic/sec/pstat modes for credential and ACL provisioning simultaneously to ensure consistency of access policy before allowing normal operation.

An OIC client asserts which role it is using by including the role string with the CoAP payload, e.g. GET /a/light; ‘role’=admin

7.3.3.4 Asymmetric Key Credentials

The ACL provisioning service (e.g. rt=“oic.sec.aps”) may digitally sign an access control list as part of issuing a /oic/sec/sacl resource. The public key used by OIC Servers to verify the signature is provisioned as part of credential provisioning. A /oic/sec/cred resource with an asymmetric key type or signed asymmetric key type is used. The PublicData property contains the ACL provisioning service's public key.

7.3.4 ACL Provisioning

During ACL provisioning, the device establishes a secure connection to an ACL provisioning service. The ACL provisioning service will instantiate or update device ACLs according to the ACL policy.

The device and ACL provisioning service may establish an observer relationship such that when a change to the ACL policy is detected; the device is notified triggering ACL provisioning.

7.4 Security Service Resource Definition (Normative)

The /oic/sec/svc resource is used to identify the credentials services used for end-to-end secure connection useful for performing security configuration.

Services Resource Definition:

TABLE 9
Secure Service resource definition

| | | | | | |
|---|---|---|---|---|---|
| | | Resource | | | Rented |
| Fixed | Resource | Type ID | Inter- | | Functional |
| URI | Type Title | (“rt” value) | faces | Description | Interaction |

| | | | | |
|---|---|---|---|---|
| /oic/sec/svc | Services | urn:oic.sec.svc | The services resource | Configuration |
| | | | contains a list of | |
| | | | services that are used | |
| | | | to configure OIC devices | |

TABLE 10
Security Service resource properties definition

| Property | Property | Value | Value | | Access | | | |
|---|---|---|---|---|---|---|---|---|
| Title | Name | Type | Rule | Unit | Mode | Mandatory | Instance | Description |
| Server | svcdid | oic.uuid | | — | R | Yes | Single | Identifies the |
| DeviceID | | | | | | | | device OIC uses to |
| | | | | | | | | establish a secure |
| | | | | | | | | connection |
| Service | svct | String | oic.sec.{Service | | R | Yes | Multiple | Type of service |
| Type | | | Type} | | | | | implemented by |
| | | | | | | | | this OIC server. |
| Supported | sct | oic.sec.cred | bitmask | | R | Yes | Single | Bitmask specifying |
| Credential | | type | | | | | | the supported |
| Types | | | | | | | | security modes |
| Server | cid | UINT16 | 0-64K-1 | | R | Yes | Single | Local reference to |
| Credential | | | | | | | | credential used to |
| ID | | | | | | | | authenticate the |
| | | | | | | | | service |
| Client | cid | UINT16 | 0-64K-1 | | R | Yes | Single | Local reference to |
| Credential | | | | | | | | credential used to |
| ID | | | | | | | | authenticate this |
| | | | | | | | | device to the |
| | | | | | | | | service |
| Resource | rowner | oic.sec.svc | oic.sec.bss | | R | Yes | Single | Refers to the |
| Owner | | | | | | | | bootstrap service |
| | | | | | | | | resource that |
| | | | | | | | | instantiates/updates |
| | | | | | | | | this resource |

Each secure end-to-end connection may identify the credentials used to authenticate the local device to the remote device and to verify the remote device credentials. The remote device may support a subset of the /oic/sec/cred credential resources, the ‘SupportedCreds’ property may be used to determine which credential resources are appropriate to supply during authentication exchanges.

Security Service Type Definitions:

The table below defines security service types. “{ServiceType}” may be used in this document to refer to an instance of a service type URN.

TABLE 11
Secure Service type definitions

| Type Name | Type URN | Description |
|---|---|---|
| Device Owner | urn:oic.sec.doxm | Service type for onboarding |
| Transfer | | devices into the network |
| Service | | |
| Bootstrap | urn:oic.sec.bss | Service type for a |
| Service | | bootstrap service |
| Credential | urn:oic.sec.cps | Service type for a credential |
| Provisioning | | provisioning service |
| Service | | |
| ACL | urn:oic.sec.aps | Service type for an ACL |
| Provisioning | | provisioning service |
| Service | | |
| Access | urn:oic.sec.ams | Service type for an Access |
| Management | | Management service |
| Service | | |
| Other | urn:{ServiceType} | Other service type definition |
| Unspecified | urn:* | Service type is intentionally not |
| | | specified and satisfies any service. |

Devices seeking to establish secure connection to this device may inquire as to which service types are supported and have accompanying credentials. This resource is exposed as part of OIC core resource introspection mechanism.

A device may identify acceptable service types used during normal operation by supplying the service type URN.

The asterisk URN explicitly asserts that a service type designation is not required.

7.5 Provisioning Status Resource (Normative)

The /oic/sec/pstat resource represents a device's provisioning status.

TABLE 12
Provisioning Status resource definition

| | | | | | |
|---|---|---|---|---|---|
| | | Resource | | | Related |
| Fixed | Resource | Type ID | Inter- | | Functional |
| URI | Type Title | (“rt” value) | faces | Description | Interaction |

| | | | | |
|---|---|---|---|---|
| /oic/sec/pstat | Provisioning | urn:oic.sec.pstat | Resource for | Configuration |
| | Status | | managing device | |
| | | | provisioning | |
| | | | status | |

TABLE 13
Provisioning Status Properties definition

| Property | Property | Value | Value | | Access | | | |
|---|---|---|---|---|---|---|---|---|
| Title | Name | Type | Rule | Units | Mode | Mandatory | Instance | Description |
| Is | IsOp | Boolean | T\|F | — | R | Yes | Single | Device can function even |
| Operational | | | | | | | | when Cm is non-zero. Device |
| | | | | | | | | will only service requests |
| | | | | | | | | related to satisfying Tm when |
| | | | | | | | | IsOp is FALSE. |
| Current | Cm | oic.sec.dpm | 0-64K−1 | — | RW | Yes | Single | Specifies the current device |
| Mode | | | | | | | | mode. |
| Target | Tm | oic.sec.dpm | 0-64K−1 | — | RW | No | Single | Specifies a target device mode |
| Mode | | | | | | | | the device is attempting to |
| | | | | | | | | enter. |
| Device | DeviceID | urn:oic.uuid | — | — | R | No | Single | Specifies the device to which |
| ID | | | | | | | | the provisioning status |
| | | | | | | | | applies. If not specified, it |
| | | | | | | | | applies to {this} device. |
| Operational | Om | oic.sec.dpom | 0-255 | | RW | Yes | Single | Current provisioning services |
| Mode | | | | | | | | operation mode |
| Supported | Sm | oic.sec.dpom | 0-255 | | R | Yes | Multiple | Supported provisioning |
| Mode | | | | | | | | services operation modes |
| Commit | Ch | oic.sec.sha256 | 0- | — | R | Yes | Single | Sha256 hash value of all |
| Hash | | | UINT256 | | | | | provisioning commands that |
| | | | | | | | | have been committed by the |
| | | | | | | | | device. |

The provisioning status resource/oic/sec/pstat is used to enable OIC devices to perform self-directed provisioning. Devices are aware of their current configuration status and a target configuration objective. When there is a difference between current and target status, the device may consult the /oic/sec/svcs resource to discover whether any suitable provisioning services exist. The OIC device may request provisioning if configured to do so. The /oic/sec/pstat?Om property will specify expected device behavior under these circumstances.

Self-directed provisioning enables devices to function with greater autonomy to minimize dependence on a central provisioning authority that may be a single point of failure in the network.

The device computes a hash of the CoAP POST or PUT command that was successfully applied by the OIC Server. The OIC Server supplies the current CommitHash property when requesting provisioning; the server extends the hash with the POST or PUT command. If the client fails to commit the POST or PUT, the CommitHash property will not reflect the uncommitted command.

Device Provisioning Mode Type Definition:

The provisioning mode type is a 16-bit mask enumerating the various device provisioning modes. “{ProvisioningMode}” may be used in this document to refer to an instance of a provisioning mode without selecting any particular value.

| Type Name | Type URN | Description |
|---|---|---|
| Device | urn:oic.sec.dpm | Device provisioning mode is a 16- |
| Provisioning | | bit bitmask describing various |
| Mode | | provisioning modes |

Device Provisioning Mode Low-Byte:

| Value | Device Mode | Description |
|---|---|---|
| bx0000,0000 | Normal | Device mode for normal operation |
| (0) | | |
| bx0000,0001 | Reset | Device reset mode enabling |
| (1) | | manufacturer reset operations |
| bx0000,0010 | Take Owner | Device pairing mode enabling owner |
| (2) | | transfer operations |
| bx0000,0100 | Bootstrap | Bootstrap service provisioning mode |
| (4) | Service | enabling instantiation of a bootstrap |
| | | service |
| bx0000,1000 | Security | Service provisioning mode enabling |
| (8) | Managerment | instantiation of device security |
| | Services | services and related credentials |
| bx0001,0000 | Provision | Credential provisioning mode |
| (16) | Credentials | enabling instantiation of pairwise |
| | | device credentials using a |
| | | management service of type |
| | | urn:oic.sec.cps |
| bx0010,0000 | Provision | ACL provisioning mode enabling |
| (32) | ACLs | instantiation of device ACLs using a |
| | | management service of type |
| | | urn:oic.sec.aps |
| bx0100,0000 | <Reserved> | Reserved for later use |
| (64) | | |
| bx1000,0000 | <Reserved> | Reserved for later use |
| (128) | | |

Device Provisioning Mode High-byte:

| Value | Device Mode | Description |
|---|---|---|
| bx0000,0000- | <Reserved> | Reserved for later use |
| bx1111,1111 | | |

Device Provisioning Operation Mode Type Definition:

The provisioning operation mode type is a 8-bit mask enumerating the various provisioning operation modes.

| Type Name | Type URN | Description |
|---|---|---|
| Device | urn:oic.sec.dpom | Device provisioning operation |
| Provisioning | | mode is a 8-bit bitmask |
| OperationMode | | describing various provisioning |
| | | operation modes |

Device Provisioning Operation Mode Bits:

| | Operation | |
|---|---|---|
| Value | Mode | Description |
| bx0000,0000 | Multiple | Provisioning related services are placed |
| (0) | devices | in different devices. Hence, a provisioned |
| | have different | device may establish multiple DTLS |
| | provisioning | sessions for each service. This condition |
| | services | exists when bit 0 is FALSE. |
| bx0000,0001 | Single device | All provisioning related services are in |
| (1) | has all | the same device. Hence, instead of |
| | provisioning | establishing multiple DTLS sessions with |
| | services | provisioning services, a provisioned |
| | | device establishes only one DTLS session |
| | | with the device. This condition exists |
| | | when bit 0 is TRUE. |
| bx0000,0010 | Provisioning | Device supports provisioning service |
| (2) | service in | control of this device's provisioning |
| | control of | operations. This condition exists when bit |
| | provisioning | 1 is TRUE. When this bit is FALSE this |
| | | device controls provisioning steps. |
| bx1111,11xx | <Reserved> | Reserved for later use |

7.6 Bootstrap Examples (Informative)

New devices may advertise their existence and need for bootstrapping using OIC core discovery services. The device maintains a provisioning status (e.g. /oic/sec/pstat) resource that establishes which provisioning tasks are needed.

Devices may operate using a self-directed strategy to bootstrap device provisioning. This is achieved when device owner transfer includes configuration of the bootstrap service. Self-directed provisioning may utilize the /oic/sec/pstat resource to manage its progress. The /oic/sec/pstat target mode value informs the bootstrap server which security services may be provisioned as part of bootstrap.

A provisioning client device may discover the new device and determine it is capable of provisioning new device. The provisioning client queries the new device's /oic/sec/pstat value to determine what provisioning actions are available. It then establishes an authenticated session over which the provisioning operations are performed.

The /oic/sec/pstat resource establishes the devices current provisioning level. A mode value of (4) asserts that the device bootstrap service and a mode value of (16) assert credentials are available for provisioning.

TABLE 14
Steps describing a provisioning-service-
led provisioning of a new device

| Step | Description |
|---|---|
| 1 | Discover devices that are owned and support provisioning-tool- |
| | led provisioning. |
| 2 | The /oic/sec/doxm resource identifies the device and it's |
| | owned status. |
| 3 | PT obtains the new device's provisioning status found |
| | in /oic/sec/pstat resource |
| 4 | The pstat resource describes the types of provisioning modes |
| | supported and which is currently configured. A device |
| | manufacturer may set a default current operational mode (Om). |
| | If the Om isn't configured for PT-led provisioning, its |
| | Om value can be changed. |
| 5-6 | PT instantiates the /oic/sec/svc resource. The svc resouce |
| | includes entries for the bootstrap service, ACL provisioning |
| | service and credential provisioning service. It references |
| | credentials that may not have been provisioned yet. |
| 7-8 | The new device provisioning status mode is updated to reflect that |
| | various services have been configured. |
| 9-10 | PT instantiates the /oic/sec/cred resource. It contains credentials |
| | for the provisioned services and other OIC devices |
| 11-12 | The new device provisioning status mode is updated to reflect that |
| | the security services have been configured. |
| 13-14 | PT instantiates /oic/sec/acl resources. |
| 15 | The new device provisioning status mode is updated to reflect that |
| | ACLs have been configured. The PT computes a hash of all the |
| | provisioning messages “CommitHash”. CommtHash is given to the |
| | new device. |
| 16 | The new device compares the CommitHash with an internal |
| | CommitHash value it has computed over the provisioning |
| | messages. If these values match, the /oic/sec/pstat.CommitHash |
| | property is updated with the new value. |
| 17 | The return code reflects successful CommitHash verification and |
| | resource update. |
| 18 | The secure session is closed. |

Figure M shows provisioning-Service-Led Provisioning of a New Device.

Table 15 shows steps for device-led provisioning of a new device using a single provisioning service.

| Step | Description |
|---|---|
| 1 | The new device verifies it is owned. |
| 2 | The new device verifies it is in self-provisioning |
| | mode. |
| 3 | The new device verifies its target provisioning state |
| | is fully provisioned. |
| 4 | The new device verifies its current provisioning state |
| | requires provisioning. |
| 5 | The new device initiates a secure session with the |
| | provisioning tool using the /oic/sec/doxm.DevOwner |
| | value to open a TLS connection using OwnerPSK. |
| 6-7 | The new device gets the /oic/sec/svc resources. The svc |
| | resource includes entries for the bootstrap service, ACL |
| | provisioning service and credential provisioning |
| | service. It references credentials that may not have |
| | been provisioned yet. |
| 8-9 | The new device gets the PT commitHash value. |
| 10 | The new device verifies the PT commitHash value matches |
| | its local value. |
| 11 | The new device updates Cm to reflect provisioning of |
| | bootstrap and other services. |
| 12-13 | The new devices gets the /oic/sec/cred resources. It |
| | contains credentials for the provisioned services and |
| | other OIC devices. |
| 14-15 | The new device gets the PT commitHash value. |
| 16 | The new device verifies the PT commitHash value matches |
| | its local value. |
| 17 | The new device updates Cm to reflect provisioning of |
| | credential resources. |
| 18-19 | The new device gets the /oic/sec/acl resources. |
| 20-21 | The new device gets the PT commitHash value. |
| 22 | The new device verifies the PT commitHash value matches |
| | its local value. |
| 23 | The new device updates Cm to reflect provisioning of |
| | ACL resources. |
| 24 | The secure session is closed. |

Table 16 shows step for device-led provisioning of a new device using multiple provisioning services.

| Step | Description |
|---|---|
| 1 | The new device verifies it is owned. |
| 2 | The new device verifies it is in self-provisioning mode. |
| 3 | The new device verifies its target provisioning state |
| | is fully provisioned. |
| 4 | The new device verifies its current provisioning state |
| | requires provisioning. |
| 5 | The new device initiates a secure session with the |
| | provisioning tool using the /oic/sec/doxm.DevOwner |
| | value to open a TLS connection using OwnerPSK. |
| 6-7 | The new device gets the /oic/sec/svc resources. The svc |
| | resource includes entries for the bootstrap service, ACL |
| | provisioning service, ACL management service and credential |
| | provisioning service. It references credentials that may not |
| | have been provisioned yet. |
| 8-9 | The new devices gets the /oic/sec/cred resources. It contains |
| | credentials for the provisioned services . . . |
| 10-11 | The new device gets the PT commitHash value. |
| 12 | The new device verifies the PT commitHash value matches its |
| | local value. |
| 13 | The new device updates Cm to reflect provisioning of support |
| | services. |
| 14 | The new device closes the DTLS session with the provisioning |
| | tool. |
| 15 | The new device finds the credential provisioning service (CPS) |
| | from the /oic/sec/svc resource and opens a DTLS connection. |
| | The new device finds the credential to use from the |
| | /oic/sec/cred resource. |
| 16-17 | The new device requests additional credentials that may be |
| | needed for interaction with other devices. |
| 18-19 | The new device gets the CPS commitHash value |
| 20 | The new device verifies the CPS commitHash value matches its |
| | local value. |
| 21 | The new device updates Cm to reflect provisioning of credential |
| | resources. |
| 22 | The DTLS connection is closed. |
| 23 | The new device finds the ACL provisioning service (APS) from |
| | the /oic/sec/svc resource and opens a DTLS connection. The new |
| | device finds the credential to use from the /oic/sec/cred resource. |
| 24-25 | The new device gets ACL resources that it will use to enforce |
| | access to local resources. |
| 26-27 | The new device may also get signed ACL resources immediately or |
| | in response to a subsequent device resource request. |
| 28-29 | The new device may also get a list of resources that may consult |
| | an Access Manager for making the access control decision. |
| 30-31 | The new device gets the APS commitHash value |
| 32 | The new device verifies the APS commitHash value matches its |
| | local value. |
| 33 | The new device updates Cm to reflect provisioning of ACL |
| | resources. |
| 34 | The DTLS connection is closed. |

Figure N is Device-led provisioning of a new device using a single provisioning service.

Figure O is an Example of a device-led provisioning of a new device with multiple provisioning services.

8 Session Protection with DTLS

DTLS sessions establish end-to-end security between OIC devices. The keys used to establish DTLS sessions are protected within the OIC framework and may use platform features for hardened key storage.

8.1 Unicast Session Semantics (Informative)

This section defines the security requirements applicable over a local IP (v4 or v6) subnet. The authentication protocol to provide E2E security for OIC over local IP is DTLS. The main rationale is that it is designed to function over lossy, connectionless networks.

Securing the communication channel between OIC client and server devices is optional. The discovery (resource introspection) and control/data plane for the resource model is done over CoAP. The OIC stack will support insecure and secure communication over distinct ports. CoAP discover and introspection is always supported on the default UDP port 5683. Secure CoAP (CoAPs) communication uses the default UDP port 5684.

DTLS implementations typically contain both the DTLS protocol implementation as well as support for reassembly/reordering, retransmission and implementation for the crypto related functions such as AES-CCM, HMAC, SHA2 etc. Many of the constrained devices have very limited storage and may already provide same crypto functions required by DTLS.

It is desired that the implementation is modularized with interfaces defined for common crypto functions so that a vendor can plug in and use their own implementation and thereby reducing the resulting code size required by the implementation.

8.1.1 Cipher Suites

The OIC stack relies upon ciphersuites that accept a pre-shared key for device authentication and to ensure interoperability. Generally, constrained devices implement minimal ciphersuite support according to constrained environment limitations, while less constrained devices implement a broad range. The strongest ciphersuite common to a pair of devices will be selected during the cipher suite negotiation—See RFC6655.

8.1.2 Device Authentication

OIC devices can maintain a credential resource containing a pre-shared key that a client device uses to authenticate to a server device and likewise a server device uses to verify the authenticity of the client device. The pre-shared key may also be used to establish a DTLS secure session.

A pair-wise PSK authenticates both devices sharing the PSK. If Device_A initiates a DTLS session using a pair-wise PSK (PSKAB) Device_B locates the service resource (/oic/sec/svc) corresponding to Device_A and PSKAB in the credential resource (/oic/sec/cred) belonging to Device_A. Device_B supplies PSKAB as input to the DTLS ciphersuite. Device_A correspondingly supplies his copy of PSKAB to the ciphersuite. If both sides supply the same PSK then the handshake succeeds.

Since there are only two instances of PSKAB, (one for Device_A and the other Device_B), Device_A concludes that the endpoint must be Device_B since Device_B is the only other device that shares this PSK. Device_B arrives at a similar conclusion given Device_A. Hence, both endpoints are authenticated by PSKAB. Both devices verify the device ID contained in the credential resource matches the device ID for the established connection.

Both devices protect PSKAB using device secure storage.

8.1.3 Device Authentication with Role Privilege

If the credential resource used to establish the DTLS session includes role designations, the OIC server responding to client requests will apply the role information to the ACL evaluation logic.

OIC credential resources may include asymmetric keys as authentication credentials. Asymmetric public keys may be signed by a third party in the form of a certificate or may be unsigned. Credential provisioning services introduce devices to one another by creating /oic/sec/cred resources containing unsigned public keys associated with a respective device identifier.

Authentication using asymmetric keys with DTLS requires negotiation of the appropriate ciphersuites. See RFC5246, RFC6367 and RFC7027.

8.2 Device Credential Resource (Normative)

8.2.1 Device Credential Resource Definition

Table 17 is a Device Credential resource definition.

| | | | | | |
|---|---|---|---|---|---|
| | | Resource | | | Related |
| Fixed | Resource | Type ID (“rt” | Inter- | | Functional |
| URI | Type Title | value) | faces | Description | Interaction |

| | | | | |
|---|---|---|---|---|
| /oic/sec/ | Creden- | urn:oic.sec.cred | Resource | Security |
| cred | tials | | containing | |
| | | | credentials for | |
| | | | device | |
| | | | authentication, | |
| | | | verification | |
| | | | and data | |
| | | | protection | |

Table 18 is a Device Credential Property definition.

| Property | Property | Value | Value | | Access | | | |
|---|---|---|---|---|---|---|---|---|
| Title | Name | Type | Rule | Unit | Mode | Mandatory | Instance | Description |
| Credential | CredID | UINT16 | 0-64K-1 | — | R | Yes | Single | Short credential ID for local |
| ID | | | | | | | | references from other resources |
| Subject | SubjectID | oic.uuid | URI | — | R | Yes | Single | Identifies the subject (e.g. |
| ID | | | | | | | | device) to which this credential |
| | | | | | | | | applies. |
| Role ID | RoleID | oic.sec. | URI | — | R | No | Multiple | Identifies the role(s) the subject |
| | | role | | | | | | is authorized to assert. |
| Credential | CredType | oic.sec. | One | — | R | Yes | Single | 0: no security mode |
| Type | | credtype | of: | | | | | 1: symmetric pair-wise key |
| | | (UINT16) | [0\| | | | | | 2: symmetric group key |
| | | | 1\|2\| | | | | | 4: asymmetric key |
| | | | 4\| | | | | | 8: signed asymmetric key (aka |
| | | | 8\| | | | | | certificate) |
| | | | 16] | | | | | 16: PIN/password |
| Public | PublicData | oic.sec. | — | — | R | No | Single | 1:2:16: friendly name |
| Data | | jwk, | | | | | | 4:8: Asymmetric public key or |
| | | string | | | | | | certificate (if signed). JSON Web |
| | | OCTET[ ] | | | | | | Key (JWK) draft-ietf-jose-json- |
| | | | | | | | | web-key-41 or X.509 certificate |
| Private | PrivateData | oic.sec. | — | — | — | No | Single | 1:2: secret symmetric key. |
| Data | | jwk, | | | | | | 4:8: Private asymmetric key. |
| | | oic.sec. | | | | | | 16: PIN/password |
| | | tee, | | | | | | This value may not be disclosed |
| | | String, | | | | | | to unauthorized entities. JSON |
| | | OCTET[ ] | | | | | | Web Key (JWK) draft-ietf-jose- |
| | | | | | | | | json-web-key-41 |
| | | | | | | | | If a TEE protects the key then |
| | | | | | | | | this value may be a handle to the |
| | | | | | | | | object in the TEE. |
| Optional | Optional | OCTET[ ] | | | R | No | Single | 8: CRL |
| Data | Data | | | | | | | |
| Period | Period | String | — | — | R | No | Single | Period as defined by RFC5545. |
| | | | | | | | | The credential may not be used if |
| | | | | | | | | the current time is outside the |
| | | | | | | | | Period window. |
| Credential | Crm | oic.sec. | — | — | R | No | Single | Credentials with a Period |
| Resource | | crm.pro | | | | | | property are refreshed using the |
| Manager | | oic.sec. | | | | | | credential refresh method (crm) |
| | | crm.dh_psk | | | | | | according to the type definitions |
| | | oic.sec. | | | | | | for oic.sec.crm |
| | | crm.dh_pin | | | | | | |
| | | oic.sec. | | | | | | |
| | | crm.kdc | | | | | | |
| Resource | Rowner | oic.sec. | oic.sec.bss, | | R | Yes | Multiple | Refers to the service resource(s) |
| owner | | svc | oic.sec. | | | | | that may instantiate/update this |
| | | | cps | | | | | resource. Rowner status has full |
| | | | | | | | | (C, R, U, D, N) permission. |

All secure device accesses may have an/oic/sec/cred resource authorizing the end-to-end interaction. A credential resource that does not specify PrivateData may be useful during testing and trial deployments prior to provisioning strong credentials. The ‘CredType’ value of ‘0’ (e.g. “no security mode”) is used for these scenarios.

The /oic/sec/cred resource can be created and modified by the service named in the ‘Rowner’ property. ACL resources MAY grant permission to OIC Clients other than the resource owner. The credential Rowner property allows credential provisioning to occur before ACL provisioning, which may be a necessity when establishing end-to-end secure connections that are prerequisite to ACL evaluation.

8.3 Ciphersuites for Dynamic Pair-Wise Key Generation (Normative)

In ad-hoc device interaction scenarios two devices can agree upon a pair-wise key that is used to protect subsequent interactions. The pairwise key is generated using a Diffie-Hellman ciphersuite.

The new pair-wise key updates the affected /oic/sec/cred resources for both devices. Establishing a pair-wise key is achieved using one of the following ciphersuites.
TLS_ECDH_ANON_WITH_AES_128_CBC_SHA, (* 16 octet integrity check *)
TLS_ECDH_ANON_WITH_AES_256_CBC_SHA,
TLS_ECDH_ANON_WITH_AES_128_CBC_SHA256,
TLS_ECDH_ANON_WITH_AES_256_CBC_SHA256,
TLS_ECDHE_PSK_WITH_AES_128_CBC_SHA, (* 16 octet integrity check *)
TLS_ECDHE_PSK_WITH_AES_256_CBC_SHA,
TLS_ECDHE_PSK_WITH_AES_128_CBC_SHA256,
TLS_ECDHE_PSK_WITH_AES_256_CBC_SHA256,
TLS_PSK_DHE_WITH_AES_128_CCM_8, (* 8 octet integrity check *)
TLS_PSK_DHE_WITH_AES_256_CCM_8,
TLS_DHE_PSK_WITH_AES_128_CCM,
TLS_DHE_PSK_WITH_AES_256_CCM,

See RFC4279, RFC5489 and RFC6655.

All OIC Devices May Implement:
TLS_ECDH_ANON_WITH_AES_128_CBC_SHA,
TLS_ECDHE_PSK_WITH_AES_128_CBC_SHA,
TLS_PSK_DHE_WITH_AES_128_CCM_8,

Class-2 and Lower Devices May Implement:
TLS_ECDH_ANON_WITH_AES_128_CBC_SHA256,
TLS_ECDH_ANON_WITH_AES_256_CBC_SHA,
TLS_ECDH_ANON_WITH_AES_256_CBC_SHA256,
TLS_ECDHE_PSK_WITH_AES_256_CBC_SHA,
TLS_ECDHE_PSK_WITH_AES_128_CBC_SHA256,
TLS_ECDHE_PSK_WITH_AES_256_CBC_SHA256,
TLS_PSK_DHE_WITH_AES_256_CCM_8,
TLS_DHE_PSK_WITH_AES_128_CCM,
TLS_DHE_PSK_WITH_AES_256_CCM,

Devices Above Class-2 May Implement:

TLS_ECDH_ANON_WITH_AES_128_CBC_SHA256,
TLS_ECDH_ANON_WITH_AES_256_CBC_SHA, TLS_ECDH_ANON_WITH_AES_256_CBC_SHA256,
TLS_ECDHE_PSK_WITH_AES_256_CBC_SHA,
TLS_ECDHE_PSK_WITH_AES_128_CBC_SHA256,
TLS_ECDHE_PSK_WITH_AES_256_CBC_SHA256,
TLS_PSK_DHE_WITH_AES_256_CCM_8,
TLS_DHE_PSK_WITH_AES_128_CCM,
TLS_DHE_PSK_WITH_AES_256_CCM,

Ciphersuites that accept a PSK may use a previously generated PSK when generating the new PSK.

The DTLS MasterSecret resulting from the TLS handshake exchange is input into a pseudo-random function (PRF) as follows:

PSK=TLS_PRF(MasterSecret,Message(DeviceID_A∥DeviceID_B∥“pair-wise-PSK”),length);
MasterSecret—is the MasterSecret value resulting from the DTLS handshake using one of the above ciphersuites.
Message is the concatenation of the following values:
DeviceID_A is the string representation of the device that supplied the DTLS ClientHello message where DeviceID=“urn:uuid:XXXX-XXXX-XXXX-XXXX”.
DeviceID_B is the device responding to the DTLS ClientHello message “pair-wise-PSK”—a string indicating intended use of the PSK.
Length of Message in bytes.

The PSK is derived by both device endpoints. The /oic/sec/cred resources that apply to the device pairing are updated by the local device.

8.3.1 Credential Refresh

Credential refresh methods specify the options by which a device may refresh an expired credential. The Period property may be used to expire a credential. If a credential refresh method is specified, the device may proactively obtain a new credential before the credential expires. In some cases the current credential may be used to obtain the new credential. All devices may support oic.sec.crm.pro. All devices may support oic.sec.crm.dhpin and oic.sec.crm.dhpsk. All devices may support oic.sec.crm.kdc and oic.sec.crm.cms as appropriate.
Table 19 shows credential refresh methods.

| | Applies | |
|---|---|---|
| | to these | |
| CRM Type | CredTypes | Description |
| oic.sec.crm.pro | [1 \| 2 \| | The credential is refreshed using |
| | 4 \| 8 \| 16] | a credential provisioning service. |
| oic.sec.crm.dh_psk | [1] | The credential is refreshed using |
| | | the existing credential with |
| | | Diffie-Hellman key agreement to |
| | | generate a new credential. The |
| | | PSK is used with DH to establish |
| | | a new session key using key |
| | | derivation function (KDF). |
| oic.sec.crm.dh_pin | [16] | The credential is refreshed using |
| | | the existing credential with |
| | | Diffie-Hellman key agreement to |
| | | generate a new credential. The PIN |
| | | is used to generate a PSK that is |
| | | supplied to DH. The resulting session |
| | | key is used to derive a new PIN. |
| oic.sec.crm.kdc | [1 \| 2] | The credential is refreshed using a |
| | | key distribution center service |
| oic.sec.cms.cms | [8] | The credential is refreshed using a |
| | | certificate management service |

8.3.1.1 Oic.sec.crm.dhpsk Mode

Using this mode, the current PSK is used to establish a Diffie-Hellmen session key in DTLS. The TLS_PRF is used as the key derivation function (KDF) that produces the new (refreshed) PSK.

PSK=TLS_PRF(MasterSecret,Message(DeviceID_A∥DeviceID_B∥“pair-wise-PSK”),length);
MasterSecret—is the MasterSecret value resulting from the DTLS handshake using one of the above ciphersuites.

Message is the concatenation of the following values:
Refresh method—I.e. “oic.sec.crm.dh_psk”

DeviceID_A is the string representation of the device that supplied the DTLS ClientHello message where DeviceID=“urn:uuid:XXXX-XXXX-XXXX-XXXX”.
DeviceID_B is the device responding to the DTLS ClientHello message
“pair-wise-PSK”—a string indicating intended use of the PSK.
Length of Message in bytes.

8.3.1.2 Oic.sec.crm.dhpin Mode

Using this mode, the current unexpired PIN is used to generate a PSK following RFC2898. The PSK is used during the Diffie-Hellman exchange to produce a new session key. The session key my be used to switch from PIN to PSK mode. Normally, the PSK is used to derive a PIN value.

The pseudo-random function (PBKDF2) defined by RFC2898. PIN is a shared value used to generate a pre-shared key. The PIN-authenticated pre-shared key (PPSK) is supplied to a TLS ciphersuite that accepts a PSK.

PPSK=PBKDF2(PRF,PIN,DeviceID,c,dkLen)

The PBKDF2 function has the following parameters:
PRF—Uses the DTLS PRF.
PIN—Shared between devices.
Refresh method—I.e. “oic.sec.crm.dhpin”
DeviceID—UUID of the new device.
c—Iteration count initialized to 1000, incremented upon each use.
dkLen—Desired length of the derived PSK in octets.

The PIN is computed by inputting the PPSK to the PRF and specifying dkLen which is the desired length of the PIN in octets. The resultant octets may be base64 encoded to produce a human readable PIN value.

9 Simple Access Control

9.1 Overview (Informative)

Access Control in the OIC stack is expected to be transport agnostic, meaning security properties implemented by the transport may not be expected to be applied consistently across an OIC system of devices. Rather, the OIC resource model implements security resources that apply security consistently. The following section defines the OIC inter-device access control mechanisms.

An access control policy is associated with OIC server resources. Access control policy may be expressed as local ACL or an Access Manager service.

OIC access control model requires every resource instance to have an associated access control policy. OIC ACLs identify associated resources. Nested resources, such as collections, can share a common ACL policy. If a nested resource is implicated by another ACL policy, the policy that precisely identifies the resource applies. No other policy is applied—through inference inheritance.

OIC Access Control List (ACL) BNF defines ACL structures. A local ACL is composed of one or more Access Control Entries (ACE). Each ACE defines the permissions of a subject along with optionally a validity period constraint. A subject-based ACE (SBACE) will match a subject requesting access with the intended resource. A role-based ACE (RBACE) will match a role the subject possesses.

ACL structure in Backus-Naur Form (BNF) notation is shown in FIG. P:

Access control lists for unknown or anonymous (unauthenticated) subjects over the insecure port is also possible and allows for a server to define default permissions for those subjects (e.g. read-only access to a specific resource instance).

Example ACL: uuid:0000-0000-0000-0000->“/oic/*” ? 0x01 (read-only)

Every device has at least one access control resource; otherwise the device is determined to need ACL provisioning. See sections on provisioning. Access to device resources will be denied until properly provisioned ACL(s) exist.

9.2 ACL Architecture (Informative)

An OIC Client device requests access to resources from an OIC Server. The OIC Server enforces access to its resources. Access requests may be authorized based on group or device credentials. The ACL architecture illustrates four client devices seeking access to server resources. A server evaluates each request using local ACL policies and access manager services.

Figure Q is a use case-1 showing simple ACL enforcement.

Use Case 1: In the first instance, device D1 receives access to resource R1 with permission Perm0 because the local ACL /oic/sec/acl/0 matches the request.

Figure R is a use case-2 showing ACL blocking resource access.

Use Case 2: In the second instance, device D2 access is denied because no local ACL match is found and no access manager policy is found.

Figure S is a use case-3 showing Access Manager Service supported ACL.

Use Case 3: In the third instance, device D3 receives access to resource R3 with permission Perm1 because the /oic/sec/amacl/0 matches a policy to consult the AMS1 service which returns Perm1.

Figure T is a use case-4 showing dynamically obtained ACL from an AMS.

Use Case 4: In the fourth instance, device D4 receives access to resource R4 with permission Perm2 because the server fails to find a matching ACL entry and returns an error identifying AM1 as an access sacl issuer. Device D4 obtains Sacl1 signed by AMS1, which it forwards to server D5. D5 verifies the sacl signature evaluates the ACL policy that grants Perm2 access.

9.3 Local Vs. Centralized ACL Processing (Informative)

OIC servers may host ACL resources locally. Local ACLs allow greater autonomy in access control processing than remote ACL processing. Access manager services improve ACL policy management. However, it becomes a central point of failure. Due to network latency overhead, ACL processing may be slower.

9.4 Local ACL Resource (Normative)

Local hosting of remote ACLs may specify an ACL policy covering every resource hosted by the OIC Server.

TABLE 20
Local ACL resource definition

| Resource | | | | |
|---|---|---|---|---|
| Name | Resource ID | Instances | Mandatory | Type URN |
| acl | /oic/sec/acl | Multiple | No | urn:oic.sec.acl |

TABLE 21
Local ACL Property definition

| | Property | | | | | | |
|---|---|---|---|---|---|---|---|
| Row # | Name | Opr | Instance | Mandatory | Type | Range | Description |
| informative | normative | normative | normative | normative | normative | normative | normative |
| 0 | Subject | R | Single | Yes | String | — | URN identifying the subjects |
| | | | | | | | {Subject} or {Role} who may |
| | | | | | | | access {Resource}. |
| 1 | Resource(s) | R | Multiple | Yes | String | Fully | URN identifying the resources |
| | | | | | | qualified | that have {Permission} rights. |
| | | | | | | URI - | NULL matches no resource. |
| | | | | | | local URI | Resource path ending in |
| | | | | | | | “<path>/*” ‘asterisk’ is a wild card |
| | | | | | | | that matching all resource |
| | | | | | | | instances at location <path>. |
| 2 | Permission | R | Single | Yes | UINT16 | 0-65535 | Access policy in least significant |
| | | | | | | | bits. |
| | | | | | | | 1st lsb: C(Create), |
| | | | | | | | 2nd lsb: R(Read, Observe, |
| | | | | | | | Discover), |
| | | | | | | | 3rd lsb: U(Write, Update) |
| | | | | | | | 4th lsb: D(Delete) |
| | | | | | | | 5th lsb: N (Notify) |
| 3 | Period | R | Multiple* | No | String | — | Period as defined by RFC5545 |
| | | | | | | | * Multiple Period/Recurrence tuple |
| | | | | | | | sets. |
| 4 | Recurrence | R | Multiple | No | String | — | Recurrence rule as defined by |
| | | | | | | | RFC5545 |
| 5 | Rowner(s) | R | Multiple | Yes | oic.sec. | oic.sec.bss, | Provisioning service authorized to |
| | | | | | svc | oic.sec.aps | read, create, update and delete |
| | | | | | | | this object. |

Local ACL resources supply policy to a resource access enforcement point within an OIC stack instance. The OIC framework gates OIC client access to OIC server resources. It evaluates the subject's request using policy in the ACL.

Resources named in the ACL policy may be fully qualified or partially qualified. Fully qualified resource references may include the device identifier of a remote device hosting the resources. Partially qualified references imply the local resource server is hosting the resource. If a fully qualified resource reference is given, the intermediary enforcing access may have a secure channel to the resource server and the resource server may verify the intermediary is authorized to act on its behalf as a resource access enforcement point.

Resource servers may include references to device and ACL resources where access enforcement is to be applied. However, access enforcement logic may not depend on these references for access control processing as access to server resources will have already been granted.

Local ACL resources identify a Rowner service that is authorized to instantiate and modify this resource. This prevents non-terminating dependency on some other ACL resource. Nevertheless, it may be desirable to grant access rights to ACL resources using an ACL resource.

9.5 Access Managers (Normative)

Access manager services centralizing access control decisions, but OIC server devices retain enforcement duties. The server may determine which ACL mechanism to use for which resource set. The /oic/sec/amacl resource is an ACL structure that specifies which resources will use an access manager service to resolve access decisions. The aclam may be used in concert with local ACLs (/oic/sec/acl).

The provisioning services resource (/oic/sec/svc) may contain an Access Manager service entry of type oic.sec.ams.

The OIC server device may open a connection to a service of type oic.sec.ams. Alternatively, the OIC server may reject the resource access request with an error that instructs the requestor to obtain a suitable access sacl. The sacl signature may be validated using the credential resource associated with a service of type oic.sec.ams.

9.5.1 Access Manager ACL Resource

Access manager ACL resource definition:

TABLE 22
Access manager ACL resource definition

| Resource | | | | |
|---|---|---|---|---|
| Name | Resource ID | Instances | Mandatory | Type URN |
| amacl | /oic/sec/amacl | Multiple | No | urn:oic.sec.amacl |

TABLE 23
Access manager ACL Property definition

| | Property | | | | | | |
|---|---|---|---|---|---|---|---|
| Row # | Name | Opr | Instances | Mandatory | Type | Range | Description |
| 0 | Resource(s) | R | Multiple* | Yes | String | — | URN identifying the resource |
| | | | | | | | instance to be accessed. (E.g. |
| | | | | | | | /oic/d). |
| 1 | Ams(s) | R | Multiple* | Yes | oic.sec.svc | oic.sec.ams | The AM service that may issue |
| | | | | | | | an access sacl on behalf of the |
| | | | | | | | requester. *Multiple AMs are |
| | | | | | | | backups in case the primary |
| | | | | | | | AM is not available. |
| 2 | Rowner(s) | R | Multiple | Yes | oic.sec.svc | oic.sec.bss, | Provisioning service authorized |
| | | | | | | oic.sec.aps | to modify this object. |

9.5.2 Signed ACL Resource

TABLE 24
Signed ACL resource definition

| Resource | | | | |
|---|---|---|---|---|
| Name | Resource ID | Instances | Mandatory | Type URN |
| sacl | /oic/sec/sacl | Multiple | No | urn:oic.sec.sacl |

TABLE 25
Signed ACL Property definition

| | Property | | | | | | |
|---|---|---|---|---|---|---|---|
| Row # | Name | Operations | Instances | Mandatory | Type | Range | Description |
| 0 | Acl | R | Multiple* | Yes | oic.sec.acl | — | A local ACL resource |
| | | | | | | | containing an access policy |
| | | | | | | | specific to the subject's |
| | | | | | | | resource request. |
| 1 | Ams | R | Single | Yes | oic.sec.svc | oic.sec.ams | The access sacl issuer |
| | | | | | | | 2service. |
| 2 | Signature | R | Single | Yes | oic.sec.pk9 | | Signature bits over the sacl. |
| | | | | | oic.sec.jws | | The signature structure |
| | | | | | | | defines the signature format. |
| | | | | | | | (e.g. JWS (draft-ietf-jose-json- |
| | | | | | | | web-signature-41), PKCS#9 |
| | | | | | | | (RFC2985) etc . . . ) |

9.6 ACL Evaluation (Normative)

Security may be compromised if access rules are misapplied. The OIC server may enforce access control policy before exposing resources to the requestor. The security manager in the OIC server authenticates the requestor if access is received via the secure port (See Section 8). If the request arrives over the unsecured port, the only ACL policies allowed are for anonymous requestors (See Section 9.1). If the anonymous ACL policy doesn't name the requested resource access is denied.

A wild card resource identifier may be used to apply a blanket policy for a collection of resources. For example, /a/light/* matches all instances of the light resource.

Evaluation of local ACL resources completes when all ACL resources have been queried and no entry can be found for the requested resource for the requestor—e.g. /oic/sec/acl/oic/sec/sacl and /oic/sec/amacl do not match the subject and the requested resource.

If an access manager ACL satisfies the request, the OIC server opens a secure connection to the Access Manager Service (AMS). If the primary AMS is unavailable, a secondary AMS may be tried. The OIC server queries the AMS supplying the subject and requested resource as filter criteria. The OIC server device ID is taken from the secure connection context and included as filter criteria by the AMS. If the AMS policy satisfies the Permission property (See 9.5.1) is returned.

If the requested resource is still not matched, the OIC server returns an error. The requester may query the OIC server to discover the configured AMS services. The OIC client may contact the AMS to request an access sacl (/oic/sec/sacl) resource. Performing the following operations makes the request:
1) OIC client: Open secure connection to AMS.
2) OIC client: GET /oic/sec/acl?device=“urn:uuid:XXX . . . ”, resource=“URI”
3) AMS: constructs a /oic/sec/sacl resource that is signed by the AMS and returns it in response to the GET command.
4) OIC client: POST /oic/sec/sacl [{sacl . . . }]
5) OIC server: verifies sacl signature using AMS credentials and installs the ACL resource if valid.
6) OIC client: retries original resource access request. This time the new ACL is included in the local acl evaluation.

The ACL contained in the /oic/sec/sacl resource may grant longer term access that satisfies repeated resource requests.

10 Device Security Considerations

10.1 DTLS Counter Measures (Normative)

When DTLS is used for message confidentiality and/or integrity protection between OIC devices the following conditional requirements are specified:
The DTLS implementation is required to implement counter measures for client hello flooding attacks using the DTLS defined cookie mechanism.
The DTLS implementation is required to implement counter measures for replay attacks via the sequence number in the header.
DTLS sessions that are attempted with same epoch for an already existing endpoint may allow for the handshake to complete then invalidate the previous session that was associated with the specific epoch.

The following example access control scenarios use synthetic data illustration purposes.

11.1 Example OIC ACL Resource:

The second local ACL (e.g. /oic/sec/acl/1)

TABLE 26
Example acl resource

| | | Property | | |
|---|---|---|---|---|
| Property | Property | Instance | | |
| Name | ID | ID | Value | Notes |
| Subject | 0 | 0 | Uuid: XXXX- . . . -XX01 | Subject with ID . . . 01 may access resources {1, 0} and |
| | | | | {1, 1} with permission {2} |
| Resource | 1 | 0 | {Device1}/oic/sh/light/* | If resource {light, ANY} @ host1 was requested, by |
| | | | | subject {0, 0}, {0, 1} or {0, 2} then grant access with |
| | | | | permission 0h001F. |
| Resource | 1 | 1 | {Device2}/oic/sh/temp/0 | If resource {temp, 0} @ host2 was requested, by |
| | | | | subject {0, 0}, {0, 1} or {0, 2} then grant access with |
| | | | | permission 0h001F |
| Permission | 2 | — | 0h001F | C, R, U, D, N permission is granted |
| Period | 3 | 0 | 20150101T180000Z/ | The period starting at 18:00:00 UTC, on Jan. 1, |
| | | | 20150102T070000Z | 2015 and ending at 07:00:00 UTC on Jan. 2, 2015 |
| Recurrence | 4 | 0 | RRULE:FREQ=WEEKLY; | Repeats the {period} every week until the last day of |
| | | | UNTIL=20150131T070000Z | January 2015. |
| Rowner | 5 | 0 | oic.sec.svc?rt=“oic.sec. | Only the ACL provisioning service listed in the |
| | | | aps” | provisioning services resource with type “oic.sec.aps” |
| | | | | may update this resource. |

11.2 Example Access Manager Service:

Access Manager Service Resource (e.g. /oic/sec/amacl/0)

TABLE 27
Example access manager resource

| Property | Property | Property | | |
|---|---|---|---|---|
| Name | ID | Instance ID | Value | Notes |
| Resource | 0 | 0 | {Device1}oic/sh/light/* | If the {Subject} wants to access |
| | | | | the /oic/sh/light/* resources at host1 and |
| | | | | an AM sacl was supplied then use the |
| | | | | {1} sacl validation credential to |
| | | | | enforce access. |
| Resource | 0 | 1 | {Device2}/oma/3 | If the {Subject} wants to access |
| | | | | the /oma/3 resource at host2 and an AM |
| | | | | sacl was supplied then use the {1} |
| | | | | sacl validation credential to enforce |
| | | | | access. |
| Resource | 0 | 2 | /* | If the {Subject} wants to access any |
| | | | | local resource and an AM sacl was |
| | | | | supplied then use the {1} sacl |
| | | | | validation credential to enforce |
| | | | | access. |
| OIC | 1 | 0 | href://<address>/oic/sec/am/0 | Forwarding reference for where |
| Access | | | | requestor may obtain a signed ACL. |
| manager | | | | |
| OIC | 1 | 1 | href://<address>/oic/sec/am/1 | Secondary forwarding reference for |
| Access | | | | where requestor may obtain a signed |
| manager | | | | ACL. |
| Rowner | 2 | 0 | oic.sec.svc?rt=“oic.sec.aps” | Only the ACL provisioning service |
| | | | | listed in the provisioning services |
| | | | | resource with type “oic.sec.aps” may |
| | | | | update this resource. |

What is claimed is:

1. A system comprising:
a content provider interface logic to receive a content license from a content provider, the content license to indicate that the system may distribute digital content associated with the content license to one or more devices;
an attestation logic to attest a state of a first device; and
a key management logic to generate a content key for the first device responsive to a request by the first device for the digital content and attestation of the first device state, and provide the content key to the first device.

2. The system of claim 1, further comprising a content rendering logic to receive the digital content from the content provider and render the digital content for the first device.

3. The system of claim 2, wherein the content rendering logic is to communicate the rendered digital content to the key management logic to enable the key management logic to send the rendered digital content to the first device to enable the first device to consume the digital content.

4. The system of claim 2, wherein the content rendering logic is to render the digital content for the first device responsive to a determination that the first device does not have rendering capability, the first device comprising an Internet of Things (IoT) device.

5. The system of claim 2, wherein the content rendering logic is to render the digital content for the first device based at least in part on device attribute information of the first device.

6. The system of claim 3, further comprising a key manager server comprising the content provider interface logic, the attestation logic and the key management logic.

7. The system of claim 6, wherein the key manager server further comprises an encryption logic to encrypt the rendered digital content received from the content rendering logic and send the encrypted rendered digital content to the first device, wherein the first device is to decrypt the encrypted rendered digital content with the content key.

8. The system of claim 1, wherein the content license indicates that the system is to be a domain controller on behalf of the digital content.

9. The system of claim 1, wherein the state of the first device comprises a security state, including existence of a trusted execution environment of the first device.

10. The system of claim 1, wherein the first device comprises a maker Internet of Things (IoT) device not having an embedded manufacturer license.

11. The system of claim 1, wherein the system comprises one or more servers, at least one of the one or more servers comprising at least one hardware processor, at least one hardware security processor and at least one secure storage, wherein the at least one hardware security processor comprises the attestation logic and the key management logic, the at least one hardware security processor to execute in a trusted execution environment inaccessible to the at least one hardware processor.

12. At least one computer readable storage medium comprising instructions that when executed enable a system to:
receive a content license from a content provider, the content license to enable the system to be a domain controller for one or more devices and indicate that the system may distribute digital content associated with the content license;
attest a state of a first device; and
generate a content key for the first device responsive to a request by the first device for the digital content and attestation of the first device state, and provide the content key to the first device, to enable the first device to decrypt the digital content.

13. The at least one computer readable storage medium of claim 12, further comprising instructions that when executed enable the system to send the digital content, received from the content provider, to a content rendering system to enable the content rendering system to render the digital content for the first device.

14. The at least one computer readable storage medium of claim 13, further comprising instructions that when executed enable the system to receive the rendered digital content from the content rendering system and send the rendered digital content to the first device to enable the first device to consume the digital content.

15. The at least one computer readable storage medium of claim 14, further comprising instructions that when executed enable the system to encrypt the rendered digital content received from the content rendering system and send the encrypted rendered digital content to the first device, the content key to enable the first device to decrypt the encrypted rendered digital content.

16. The at least one computer readable storage medium of claim 13, further comprising instructions that when executed enable the system to determine whether the first device has rendering capability based at least in part on device attribute information received from the first device and send the digital content to the content rendering system responsive to a determination that the first device does not have the rendering capability.

17. A system comprising:
a key management server having a hardware processor and a security engine, the security engine to receive a content license from a content provider, the content license to indicate that the key management server may distribute digital content associated with the content license to a plurality of devices for which the key management server is a domain controller, attest a state of a first device, generate a content key for the first device responsive to a request by the first device for the digital content and attestation of the first device state, and provide the content key to the first device; and
the plurality of devices coupled to the key management server, wherein at least some of the plurality of devices do not include an embedded manufacturer license to handle digital content.

18. The system of claim 17, further comprising a content rendering server coupled to the key management server to receive the digital content and render the digital content for the first device, wherein the content rendering server is to communicate the rendered digital content to the key management server to enable the key management server to send the rendered digital content to the first device to enable the first device to consume the digital content.

19. The system of claim 18, wherein the key management server is to encrypt the rendered digital content received from the content rendering server and send the encrypted rendered digital content to the first device, wherein the first device is to decrypt the encrypted rendered digital content with the content key.

20. The system of claim 17, wherein the key management server is to send a shared key to a first subset of the plurality of devices to enable the first subset of the plurality of devices to decrypt first digital content.

21. The system of claim 20, wherein the key management server is to concurrently send the first digital content to the first subset of the plurality of devices via a multi-cast communication channel.
